(19) United States
(12) Patent Application Publication
(10) Pub. No.: US 2024/0303701 A1
(43) Pub. Date: Sep. 12, 2024

(54) DIGITAL FINANCIAL MANAGEMENT HAVING CHAT SUPPORT PLATFORM TO FACILITATE TRANSER OF CHAT TRANSCRIPT BY USER COMMAND

(71) Applicant: Truist Bank, Charlotte, NC (US)

(72) Inventor: Barath Jayaraman, Charlotte, NC (US)

(21) Appl. No.: 18/180,753

(22) Filed: Mar. 8, 2023

(51) Int. Cl. G06Q 30/02

(52) U.S. Cl. CPC G06Q 30/0281

(57) ABSTRACT

A computing device, a computer program product, and a computer-implemented method for delivering enhanced financial services and, more particularly, for facilitating enhanced network communication between a user and a financial institution via a client device. A digital financial management platform for the client device includes a chat support platform that facilitates an enhanced user chat experience by transmitting, on command by the user during a virtual chat communication session, an electronic file of the transcript associated with the virtual chat communication session or a previous virtual chat communication session conducted between the user and a virtual support agent of the financial institution. The electronic file may contain all or selective portions of the transcript associated with the virtual chat communication session and/or the previous virtual chat communication session. The user may, in turn, save the electronic file locally to a client device for future use or reference.

### TECHNICAL FIELD

The present disclosure relates to a computing device, computer program product, and computer-implemented method for delivering digital financial services and, more particularly, for a chat support platform that facilitates an enhanced user chat experience by transmitting, on command by the user during a virtual chat communication session between a virtual support agent of a financial institution and the user on a client device executing a mobile application or desktop application associated with the financial institution over a communication network, an electronic file of the transcript associated with the virtual chat communication session or a previous virtual chat communication session.

### BACKGROUND

Financial institutions that provide financial services are increasingly providing a greater number of client services. In order to alleviate call and chat density from customers over a network environment, such client services include automated support agents (e.g., a chatbot) who supplement human support agents by directly interacting with customers via text chat, phone, instant messaging, etc. The data and information shared by the user and the virtual support agent in a virtual chat communication session is stored in a storage location by the financial institution. In some instances, a chat session may involve a virtual support agent providing a user with data and information that may be of some use to the user at a later point in future, i.e., after the conclusion of the chat session.

### SUMMARY

The present disclosure relates to a computing device, a computer program product, and a computer-implemented method for delivering enhanced digital financial services over a communication network by providing a digital financial management platform for a client device that includes a chat support platform that facilitates an enhanced user chat experience. The chat support platform facilitates a more enhanced chat experience by transmitting, on command by the user during a virtual chat communication session between a virtual support agent of a financial institution and the user on a client device executing a mobile application or desktop application associated with the financial institution over a communication network, an electronic file (e.g., PDF, HTML, HTM, XLS, XLSX, txt, image, audio, etc.) of the transcript associated with the virtual chat communication session. The electronic file may contain all or selective portions of the transcript associated with the virtual chat communication session. The user may, in turn, save the electronic file locally to a client device for future use or reference by the user. The electronic file may be encrypted and/or password protected before transmission to the client device. Alternatively or additionally, should any data and information within the transcript be considered personally identifiable information (PII) of the user, such data and information may be redacted automatically or by user command.

For instance, during the virtual chat communication session, the user may request, via a client device, wiring instructions on transmitting an international wire. Contemporaneously with the virtual chat communication session, the user may command or request, via the client device, a copy of the electronic file containing the entire transcript associated with the virtual chat communication session. Alternatively, the user may command a copy of the electronic file contain only the portion(s) of the transcript containing the information pertaining to wiring instructions on transmitting an international wire. In that way, the user may save the electronic file locally to the client device or another client device for later use, e.g., when transmitting an international wire or other tasks related to the one or more financial accounts of the user.

In accordance with one or more embodiments set forth, illustrated, and described herein, an apparatus may comprise one or more of the following: one or more processors; and a non-transitory memory coupled to the one or more processors, the non-transitory memory including a set of instructions of computer-executable program code, which when executed by the one or more processors, cause the apparatus to: cause, during execution of a mobile application or desktop application associated with a financial institution by a client device of a user over a communication network, a visual display of a chat interface on the client device to facilitate a virtual chat communication session between the user and a virtual support agent of the financial institution; receive, from the client device contemporaneously with the virtual chat communication session, a command to receive a copy of an electronic file of a transcript associated with the virtual chat communication session; and transmit, in response to the command, the copy of the electronic file to the client device.

In accordance with one or more embodiments set forth, illustrated, and described herein, an apparatus may comprise one or more of the following: one or more processors; and a non-transitory memory coupled to the one or more processors, the non-transitory memory including a set of instructions of computer-executable program code, which when executed by the one or more processors, cause the apparatus to: cause, during execution of a mobile application or desktop application associated with a financial institution by a client device of a user over a communication network, a visual display of a chat interface on the client device to facilitate a virtual chat communication session between the user and a virtual support agent of the financial institution; receive, from the client device contemporaneously with the virtual chat communication session, a command to receive a copy of an electronic file of a transcript associated with the virtual chat communication session; receive, from the client device, a command to terminate the virtual chat communication session; and transmit, in response to the command to terminate, the copy of the electronic file to the client device.

In accordance with one or more embodiments set forth, illustrated, and described herein, an apparatus may comprise one or more of the following: one or more processors; and a non-transitory memory coupled to the one or more processors, the non-transitory memory including a set of instructions of computer-executable program code, which when executed by the one or more processors, cause the apparatus to: cause, during execution of a mobile application or desktop application associated with a financial institution by a client device of a user over a communication network, a visual display of a chat interface on the client device to facilitate a virtual chat communication session between the user and a virtual support agent of the financial institution; receive, from the client device contemporaneously with the virtual chat communication session, a command to receive a copy of an electronic file of an entire transcript associated with the virtual chat communication session; and transmit, in response to the command, the copy of the electronic file to the client device.

In accordance with one or more embodiments set forth, illustrated, and described herein, an apparatus may comprise one or more of the following: one or more processors; and a non-transitory memory coupled to the one or more processors, the non-transitory memory including a set of instructions of computer-executable program code, which when executed by the one or more processors, cause the apparatus to: cause, during execution of a mobile application or desktop application associated with a financial institution by a client device of a user over a communication network, a visual display of a chat interface on the client device to facilitate a virtual chat communication session between the user and a virtual support agent of the financial institution; receive, from the client device contemporaneously with the virtual chat communication session, a command to receive a copy of an electronic file of an entire transcript associated with the virtual chat communication session; receive, from the client device, a command to terminate the virtual chat communication session; and transmit, in response to the command to terminate, the copy of the electronic file to the client device.

In accordance with one or more embodiments set forth, illustrated, and described herein, an apparatus may comprise one or more of the following: one or more processors; and a non-transitory memory coupled to the one or more processors, the non-transitory memory including a set of instructions of computer-executable program code, which when executed by the one or more processors, cause the apparatus to: cause, during execution of a mobile application or desktop application associated with a financial institution by a client device of a user over a communication network, a visual display of a chat interface on the client device to facilitate a virtual chat communication session between the user and a virtual support agent of the financial institution; receive, from the client device contemporaneously with the virtual chat communication session, a command to receive a copy of an electronic file of selective portions of a transcript associated with the virtual chat communication session; and transmit, in response to the command, the copy of the electronic file to the client device.

In accordance with one or more embodiments set forth, illustrated, and described herein, an apparatus may comprise one or more of the following: one or more processors; and a non-transitory memory coupled to the one or more processors, the non-transitory memory including a set of instructions of computer-executable program code, which when executed by the one or more processors, cause the apparatus to: cause, during execution of a mobile application or desktop application associated with a financial institution by a client device of a user over a communication network, a visual display of a chat interface on the client device to facilitate a virtual chat communication session between the user and a virtual support agent of the financial institution; receive, from the client device contemporaneously with the virtual chat communication session, a command to receive a copy of an electronic file of selective portions of a transcript associated with the virtual chat communication session; receive, from the client device, a command to terminate the virtual chat communication session; and transmit, in response to the command to terminate, the copy of the electronic file to the client device.

In accordance with one or more embodiments set forth, illustrated, and described herein, an apparatus may comprise one or more of the following: one or more processors; and a non-transitory memory coupled to the one or more processors, the non-transitory memory including a set of instructions of computer-executable program code, which when executed by the one or more processors, cause the apparatus to: cause, during execution of a mobile application or desktop application associated with a financial institution by a client device of a user over a communication network, a visual display of a chat interface on the client device to facilitate a virtual chat communication session between the user and a virtual support agent of the financial institution; receive, from the client device contemporaneously with the virtual chat communication session, a command to receive a copy of an electronic file of a transcript associated with a previous virtual chat communication session conducted temporally before the virtual chat communication session; and transmit, in response to the command, the copy of the electronic file to the client device.

In accordance with one or more embodiments set forth, illustrated, and described herein, an apparatus may comprise one or more of the following: one or more processors; and a non-transitory memory coupled to the one or more processors, the non-transitory memory including a set of instructions of computer-executable program code, which when executed by the one or more processors, cause the apparatus to: cause, during execution of a mobile application or desktop application associated with a financial institution by a client device of a user over a communication network, a visual display of a chat interface on the client device to facilitate a virtual chat communication session between the user and a virtual support agent of the financial institution; receive, from the client device contemporaneously with the virtual chat communication session, a command to receive a copy of an electronic file of a transcript associated with a previous virtual chat communication session conducted temporally before the virtual chat communication session; receive, from the client device, a command to terminate the virtual chat communication session; and transmit, in response to the command to terminate, the copy of the electronic file to the client device.

In accordance with one or more embodiments set forth, illustrated, and described herein, an apparatus may comprise one or more of the following: one or more processors; and a non-transitory memory coupled to the one or more processors, the non-transitory memory including a set of instructions of computer-executable program code, which when executed by the one or more processors, cause the apparatus to: cause, during execution of a mobile application or desktop application associated with a financial institution by a client device of a user over a communication network, a visual display of a chat interface on the client device to facilitate a virtual chat communication session between the user and a virtual support agent of the financial institution; receive, from the client device contemporaneously with the virtual chat communication session, a command to receive a copy of an electronic file of an entire transcript associated with a previous virtual chat communication session conducted temporally before the virtual chat communication session; and transmit, in response to the command, the copy of the electronic file to the client device.

In accordance with one or more embodiments set forth, illustrated, and described herein, an apparatus may comprise one or more of the following: one or more processors; and a non-transitory memory coupled to the one or more processors, the non-transitory memory including a set of instructions of computer-executable program code, which when executed by the one or more processors, cause the apparatus to: cause, during execution of a mobile application or desktop application associated with a financial institution by a client device of a user over a communication network, a visual display of a chat interface on the client device to facilitate a virtual chat communication session between the user and a virtual support agent of the financial institution; receive, from the client device contemporaneously with the virtual chat communication session, a command to receive a copy of an electronic file of an entire transcript associated with a previous virtual chat communication session conducted temporally before the virtual chat communication session; receive, from the client device, a command to terminate the virtual chat communication session; and transmit, in response to the command to terminate, the copy of the electronic file to the client device.

In accordance with one or more embodiments set forth, illustrated, and described herein, an apparatus may comprise one or more of the following: one or more processors; and a non-transitory memory coupled to the one or more processors, the non-transitory memory including a set of instructions of computer-executable program code, which when executed by the one or more processors, cause the apparatus to: cause, during execution of a mobile application or desktop application associated with a financial institution by a client device of a user over a communication network, a visual display of a chat interface on the client device to facilitate a virtual chat communication session between the user and a virtual support agent of the financial institution; receive, from the client device contemporaneously with the virtual chat communication session, a command to receive a copy of an electronic file of selective portions of a transcript associated with a previous virtual chat communication session conducted temporally before the virtual chat communication session; and transmit, in response to the command, the copy of the electronic file to the client device.

In accordance with one or more embodiments set forth, illustrated, and described herein, an apparatus may comprise one or more of the following: one or more processors; and a non-transitory memory coupled to the one or more processors, the non-transitory memory including a set of instructions of computer-executable program code, which when executed by the one or more processors, cause the apparatus to: cause, during execution of a mobile application or desktop application associated with a financial institution by a client device of a user over a communication network, a visual display of a chat interface on the client device to facilitate a virtual chat communication session between the user and a virtual support agent of the financial institution; receive, from the client device contemporaneously with the virtual chat communication session, a command to receive a copy of an electronic file of selective portions of a transcript associated with a previous virtual chat communication session conducted temporally before the virtual chat communication session; receive, from the client device, a command to terminate the virtual chat communication session; and transmit, in response to the command to terminate, the copy of the electronic file to the client device.

In accordance with each respective apparatus, the set of instructions, which when executed by the one or more processors, cause the apparatus to execute, temporally before transmitting the electronic file to the client device and in response to the command, encryption of the electronic file(s).

In accordance with each respective apparatus, each command comprises a verbal command.

In accordance with each respective apparatus, the set of instructions, which when executed by the one or more processors, cause the apparatus to execute natural language processing (NLP) of each verbal command.

In accordance with each respective apparatus, each command comprises a textual command.

In accordance with each respective apparatus, the set of instructions, which when executed by the one or more processors, cause the apparatus to execute natural language processing (NLP) of each textual command.

In accordance with each respective apparatus, the set of instructions, which when executed by the one or more processors, cause the apparatus to execute, in response to the command to receive the copy of the electronic file of the transcript associated with a previous virtual chat communication session, a search of a storage location for the electronic file.

In accordance with each respective apparatus, the search of the storage location for the electronic file is based on a time stamp associated with the previous virtual chat communication session.

In accordance with each respective apparatus, the search of the storage location for the electronic file is based on a one or more keywords associated with the previous virtual chat communication session.

In accordance with each respective apparatus, the set of instructions, which when executed by the one or more processors, cause the apparatus to execute, in response to the command to receive the copy of the electronic file of selective portions of the transcript associated with a previous virtual chat communication session, a search of a storage location for the electronic file for the selective portions of the transcript.

In accordance with each respective apparatus, the search of the storage location for the electronic file is based on a time stamp associated with the selective portions of the transcript.

In accordance with each respective apparatus, the search of the storage location for the electronic file is based on a one or more keywords associated with the selective portions of the transcript.

In accordance with each respective apparatus, the previous virtual chat communication session is identified by the user via a time stamp associated therewith.

In accordance with each respective apparatus, the set of instructions, which when executed by the one or more processors, cause the apparatus to transmit, in response to transmitting the electronic file of the transcript associated with the previous virtual chat communication session, an electronic notification of the transmission.

In accordance with each respective apparatus, the electronic notification includes a time stamp indicating when the deletion was completed.

In accordance with each respective apparatus, the electronic notification comprises a text message.

In accordance with each respective apparatus, the electronic notification comprises a chat message in a chat window associated with the virtual chat communication session.

In accordance with each respective apparatus, the set of instructions, which when executed by the one or more processors, cause the apparatus to enable, in response to transmitting the electronic file to the client device, a visual display of a graphical user interface (GUI) on a user interface of the client device, the GUI comprising pop-up notification of the transmission.

In accordance with each respective apparatus, the pop-up notification includes a time stamp indicating when the transmission was completed.

In accordance with each respective apparatus, the apparatus comprises a server associated with the financial institution.

In accordance with one or more embodiments set forth, illustrated, and described herein, a computer program product comprising at least one non-transitory computer readable medium having with a set of instructions of computer-executable program code, which when executed by one or more processors of a computing device, cause the computing device to execute one or more of the following: cause, during execution of a mobile application or desktop application associated with a financial institution by a client device of a user over a communication network, a visual display of a chat interface on the client device to facilitate a virtual chat communication session between the user and a virtual support agent of the financial institution; receive, from the client device contemporaneously with the virtual chat communication session, a command to receive a copy of an electronic file of a transcript associated with the virtual chat communication session; and transmit, in response to the command, the copy of the electronic file to the client device.

In accordance with one or more embodiments set forth, illustrated, and described herein, a computer program product comprising at least one non-transitory computer readable medium having with a set of instructions of computer-executable program code, which when executed by one or more processors of a computing device, cause the computing device to execute one or more of the following: cause, during execution of a mobile application or desktop application associated with a financial institution by a client device of a user over a communication network, a visual display of a chat interface on the client device to facilitate a virtual chat communication session between the user and a virtual support agent of the financial institution; receive, from the client device contemporaneously with the virtual chat communication session, a command to receive a copy of an electronic file of a transcript associated with the virtual chat communication session; receive, from the client device, a command to terminate the virtual chat communication session; and transmit, in response to the command to terminate, the copy of the electronic file to the client device.

In accordance with one or more embodiments set forth, illustrated, and described herein, a computer program product comprising at least one non-transitory computer readable medium having with a set of instructions of computer-executable program code, which when executed by one or more processors of a computing device, cause the computing device to execute one or more of the following: cause, during execution of a mobile application or desktop application associated with a financial institution by a client device of a user over a communication network, a visual display of a chat interface on the client device to facilitate a virtual chat communication session between the user and a virtual support agent of the financial institution; receive, from the client device contemporaneously with the virtual chat communication session, a command to receive a copy of an electronic file of an entire transcript associated with the virtual chat communication session; and transmit, in response to the command, a copy of the electronic file to the client device.

In accordance with one or more embodiments set forth, illustrated, and described herein, a computer program product comprising at least one non-transitory computer readable medium having with a set of instructions of computer-executable program code, which when executed by one or more processors of a computing device, cause the computing device to execute one or more of the following: cause, during execution of a mobile application or desktop application associated with a financial institution by a client device of a user over a communication network, a visual display of a chat interface on the client device to facilitate a virtual chat communication session between the user and a virtual support agent of the financial institution; receive, from the client device contemporaneously with the virtual chat communication session, a command to receive a copy of an electronic file of an entire transcript associated with the virtual chat communication session; receive, from the client device, a command to terminate the virtual chat communication session; and transmit, in response to the command to terminate, a copy of the electronic file to the client device.

In accordance with one or more embodiments set forth, illustrated, and described herein, a computer program product comprising at least one non-transitory computer readable medium having with a set of instructions of computer-executable program code, which when executed by one or more processors of a computing device, cause the computing device to execute one or more of the following: cause, during execution of a mobile application or desktop application associated with a financial institution by a client device of a user over a communication network, a visual display of a chat interface on the client device to facilitate a virtual chat communication session between the user and a virtual support agent of the financial institution; receive, from the client device contemporaneously with the virtual chat communication session, a command to receive a copy of an electronic file of selective portions of a transcript associated with the virtual chat communication session; and transmit, in response to the command, a copy of the electronic file to the client device.

In accordance with one or more embodiments set forth, illustrated, and described herein, a computer program product comprising at least one non-transitory computer readable medium having with a set of instructions of computer-executable program code, which when executed by one or more processors of a computing device, cause the computing device to execute one or more of the following: cause, during execution of a mobile application or desktop application associated with a financial institution by a client device of a user over a communication network, a visual display of a chat interface on the client device to facilitate a virtual chat communication session between the user and a virtual support agent of the financial institution; receive, from the client device contemporaneously with the virtual chat communication session, a command to receive a copy of an electronic file of selective portions of a transcript associated with the virtual chat communication session; receive, from the client device, a command to terminate the virtual chat communication session; and transmit, in response to the command to terminate, a copy of the electronic file to the client device.

In accordance with one or more embodiments set forth, illustrated, and described herein, a computer program product comprising at least one non-transitory computer readable medium having with a set of instructions of computer-executable program code, which when executed by one or more processors of a computing device, cause the computing device to execute one or more of the following: cause, during execution of a mobile application or desktop application associated with a financial institution by a client device of a user over a communication network, a visual display of a chat interface on the client device to facilitate a virtual chat communication session between the user and a virtual support agent of the financial institution; receive, from the client device contemporaneously with the virtual chat communication session, a command to receive a copy of an electronic file of a transcript associated with a previous virtual chat communication session conducted temporally before the virtual chat communication session; and transmit, in response to the command, a copy of the electronic file to the client device.

In accordance with one or more embodiments set forth, illustrated, and described herein, a computer program product comprising at least one non-transitory computer readable medium having with a set of instructions of computer-executable program code, which when executed by one or more processors of a computing device, cause the computing device to execute one or more of the following: cause, during execution of a mobile application or desktop application associated with a financial institution by a client device of a user over a communication network, a visual display of a chat interface on the client device to facilitate a virtual chat communication session between the user and a virtual support agent of the financial institution; receive, from the client device contemporaneously with the virtual chat communication session, a command to receive a copy of an electronic file of a transcript associated with a previous virtual chat communication session conducted temporally before the virtual chat communication session; receive, from the client device, a command to terminate the virtual chat communication session; and transmit, in response to the command to terminate, a copy of the electronic file to the client device.

In accordance with one or more embodiments set forth, illustrated, and described herein, a computer program product comprising at least one non-transitory computer readable medium having with a set of instructions of computer-executable program code, which when executed by one or more processors of a computing device, cause the computing device to execute one or more of the following: cause, during execution of a mobile application or desktop application associated with a financial institution by a client device of a user over a communication network, a visual display of a chat interface on the client device to facilitate a virtual chat communication session between the user and a virtual support agent of the financial institution; receive, from the client device contemporaneously with the virtual chat communication session, a command to receive a copy of an electronic file of an entire transcript associated with a previous virtual chat communication session conducted temporally before the virtual chat communication session; and transmit, in response to the command, a copy of the electronic file to the client device.

In accordance with one or more embodiments set forth, illustrated, and described herein, a computer program product comprising at least one non-transitory computer readable medium having with a set of instructions of computer-executable program code, which when executed by one or more processors of a computing device, cause the computing device to execute one or more of the following: cause, during execution of a mobile application or desktop application associated with a financial institution by a client device of a user over a communication network, a visual display of a chat interface on the client device to facilitate a virtual chat communication session between the user and a virtual support agent of the financial institution; receive, from the client device contemporaneously with the virtual chat communication session, a command to receive a copy of an electronic file of an entire transcript associated with a previous virtual chat communication session conducted temporally before the virtual chat communication session; receive, from the client device, a command to terminate the virtual chat communication session; and transmit, in response to the command to terminate, a copy of the electronic file to the client device.

In accordance with one or more embodiments set forth, illustrated, and described herein, a computer program product comprising at least one non-transitory computer readable medium having with a set of instructions of computer-executable program code, which when executed by one or more processors of a computing device, cause the computing device to execute one or more of the following: cause, during execution of a mobile application or desktop application associated with a financial institution by a client device of a user over a communication network, a visual display of a chat interface on the client device to facilitate a virtual chat communication session between the user and a virtual support agent of the financial institution; receive, from the client device contemporaneously with the virtual chat communication session, a command to receive a copy of an electronic file of selective portions of a transcript associated with a previous virtual chat communication session conducted temporally before the virtual chat communication session; and transmit, in response to the command, a copy of the electronic file to the client device.

In accordance with one or more embodiments set forth, illustrated, and described herein, a computer program product comprising at least one non-transitory computer readable medium having with a set of instructions of computer-executable program code, which when executed by one or more processors of a computing device, cause the computing device to execute one or more of the following: cause, during execution of a mobile application or desktop application associated with a financial institution by a client device of a user over a communication network, a visual display of a chat interface on the client device to facilitate a virtual chat communication session between the user and a virtual support agent of the financial institution; receive, from the client device contemporaneously with the virtual chat communication session, a command to receive a copy of an electronic file of selective portions of a transcript associated with a previous virtual chat communication session conducted temporally before the virtual chat communication session; receive, from the client device, a command to terminate the virtual chat communication session; and transmit, in response to the command to terminate, a copy of the electronic file to the client device.

In accordance with each respective computer program product, the set of instructions, which when executed by the one or more processors, cause the computing device to execute, temporally before transmitting the electronic file to the client device and in response to the command, encryption of the electronic file(s).

In accordance with each respective computer program product, each command comprises a verbal command.

In accordance with each respective computer program product, the set of instructions, which when executed by the one or more processors, cause the computing device to execute natural language processing (NLP) of each verbal command.

In accordance with each respective computer program product, each command comprises a textual command.

In accordance with each respective computer program product, the set of instructions, which when executed by the one or more processors, cause the computing device to execute natural language processing (NLP) of each textual command.

In accordance with each respective computer program product, the set of instructions, which when executed by the one or more processors, cause the computing device to execute, in response to the command to receive the copy of the electronic file of the transcript associated with a previous virtual chat communication session, a search of a storage location for the electronic file.

In accordance with each respective computer program product, the search of the storage location for the electronic file is based on a time stamp associated with the previous virtual chat communication session.

In accordance with each respective computer program product, the search of the storage location for the electronic file is based on a one or more keywords associated with the previous virtual chat communication session.

In accordance with each respective computer program product, the set of instructions, which when executed by the one or more processors, cause the computing device to execute, in response to the command to receive the copy of the electronic file of selective portions of the transcript associated with a previous virtual chat communication session, a search of a storage location for the electronic file that includes the selective portions of the transcript.

In accordance with each respective computer program product, the search of the storage location for the electronic file is based on a time stamp associated with the selective portions of the transcript.

In accordance with each respective computer program product, the search of the storage location for the electronic file is based on a one or more keywords associated with the selective portions of the transcript.

In accordance with each respective computer program product, the previous virtual chat communication session is identified by the user via a time stamp associated therewith.

In accordance with each respective computer program product, the set of instructions, which when executed by the one or more processors, cause the computing device to transmit, in response to transmitting the electronic file of the transcript associated with the previous virtual chat communication session, an electronic notification of the transmission to the client device.

In accordance with each respective computer program product, the electronic notification includes a time stamp indicating when the deletion was completed. In accordance with each respective apparatus, the electronic notification comprises a text message.

In accordance with each respective computer program product, the electronic notification comprises a chat message in a chat window associated with the virtual chat communication session.

In accordance with each respective computer program product, the set of instructions, which when executed by the one or more processors, cause the computing device to enable, in response to transmitting the electronic file to the client device, a visual display of a graphical user interface (GUI) on a user interface of the client device, the GUI comprising pop-up notification of the transmission.

In accordance with each respective computer program product, the pop-up notification includes a time stamp indicating when the transmission was completed.

In accordance with each respective computer program product, the computing device comprises a server associated with the financial institution.

In accordance with one or more embodiments set forth, illustrated, and described herein, a computer-implemented method may comprise one or more of the following: causing, by one or more financial institution servers associated with a financial institution during execution of a mobile application or desktop application associated with the financial institution by a client device of a user over a communication network, a visual display of a chat interface on the client device to facilitate a virtual chat communication session between the user and a virtual support agent of the financial institution; receiving, by the one or more financial institution servers from the client device contemporaneously with the virtual chat communication session, a command to receive a copy of an electronic file of a transcript associated with the virtual chat communication session; and transmitting, by the one or more financial institution servers in response to the command, a copy of the electronic file to the client device.

In accordance with one or more embodiments set forth, illustrated, and described herein, a computer-implemented method may comprise one or more of the following: causing, by one or more financial institution servers associated with a financial institution during execution of a mobile application or desktop application associated with the financial institution by a client device of a user over a communication network, a visual display of a chat interface on the client device to facilitate a virtual chat communication session between the user and a virtual support agent of the financial institution; receiving, by the one or more financial institution servers from the client device contemporaneously with the virtual chat communication session, a command to receive a copy of an electronic file of a transcript associated with the virtual chat communication session; receiving, by the one or more financial institution servers from the client device, a command to terminate the virtual chat communication session; and transmitting, by the one or more financial institution servers in response to the command to terminate, a copy of the electronic file to the client device.

In accordance with one or more embodiments set forth, illustrated, and described herein, a computer-implemented method may comprise one or more of the following: causing, by one or more financial institution servers associated with a financial institution during execution of a mobile application or desktop application associated with the financial institution by a client device of a user over a communication network, a visual display of a chat interface on the client device to facilitate a virtual chat communication session between the user and a virtual support agent of the financial institution; receiving, by the one or more financial institution servers from the client device contemporaneously with the virtual chat communication session, a command to receive a copy of an electronic file of an entire transcript associated with the virtual chat communication session; and transmitting, by the one or more financial institution servers in response to the command, a copy of the electronic file to the client device.

In accordance with one or more embodiments set forth, illustrated, and described herein, a computer-implemented method may comprise one or more of the following: causing, by one or more financial institution servers associated with a financial institution during execution of a mobile application or desktop application associated with the financial institution by a client device of a user over a communication network, a visual display of a chat interface on the client device to facilitate a virtual chat communication session between the user and a virtual support agent of the financial institution; receiving, by the one or more financial institution servers from the client device contemporaneously with the virtual chat communication session, a command to receive a copy of an electronic file of an entire transcript associated with the virtual chat communication session; receiving, by the one or more financial institution servers from the client device, a command to terminate the virtual chat communication session; and transmitting, by the one or more financial institution servers in response to the command to terminate, a copy of the electronic file to the client device.

In accordance with one or more embodiments set forth, illustrated, and described herein, a computer-implemented method may comprise one or more of the following: causing, by one or more financial institution servers associated with a financial institution during execution of a mobile application or desktop application associated with the financial institution by a client device of a user over a communication network, a visual display of a chat interface on the client device to facilitate a virtual chat communication session between the user and a virtual support agent of the financial institution; receiving, by the one or more financial institution servers from the client device contemporaneously with the virtual chat communication session, a command to receive a copy of an electronic file of selective portions of a transcript associated with the virtual chat communication session; and transmitting, by the one or more financial institution servers in response to the command, a copy of the electronic file to the client device.

In accordance with one or more embodiments set forth, illustrated, and described herein, a computer-implemented method may comprise one or more of the following: causing, by one or more financial institution servers associated with a financial institution during execution of a mobile application or desktop application associated with the financial institution by a client device of a user over a communication network, a visual display of a chat interface on the client device to facilitate a virtual chat communication session between the user and a virtual support agent of the financial institution; receiving, by the one or more financial institution servers from the client device contemporaneously with the virtual chat communication session, a command to receive a copy of an electronic file of selective portions of a transcript associated with the virtual chat communication session; receiving, by the one or more financial institution servers from the client device, a command to terminate the virtual chat communication session; and transmitting, by the one or more financial institution servers in response to the command to terminate, a copy of the electronic file to the client device.

In accordance with one or more embodiments set forth, illustrated, and described herein, a computer-implemented method may comprise one or more of the following: causing, by one or more financial institution servers associated with a financial institution during execution of a mobile application or desktop application associated with the financial institution by a client device of a user over a communication network, a visual display of a chat interface on the client device to facilitate a virtual chat communication session between the user and a virtual support agent of the financial institution; receiving, by the one or more financial institution servers from the client device contemporaneously with the virtual chat communication session, a command to receive a copy of an electronic file of a transcript associated with a previous virtual chat communication session conducted temporally before the virtual chat communication session; and transmitting, by the one or more financial institution servers in response to the command, a copy of the electronic file to the client device.

In accordance with one or more embodiments set forth, illustrated, and described herein, a computer-implemented method may comprise one or more of the following: causing, by one or more financial institution servers associated with a financial institution during execution of a mobile application or desktop application associated with the financial institution by a client device of a user over a communication network, a visual display of a chat interface on the client device to facilitate a virtual chat communication session between the user and a virtual support agent of the financial institution; receiving, by the one or more financial institution servers from the client device contemporaneously with the virtual chat communication session, a command to receive a copy of an electronic file of a transcript associated with a previous virtual chat communication session conducted temporally before the virtual chat communication session; receiving, by the one or more financial institution servers from the client device, a command to terminate the virtual chat communication session; and transmitting, by the one or more financial institution servers in response to the command to terminate, a copy of the electronic file to the client device.

In accordance with one or more embodiments set forth, illustrated, and described herein, a computer-implemented method may comprise one or more of the following: causing, by one or more financial institution servers associated with a financial institution during execution of a mobile application or desktop application associated with the financial institution by a client device of a user over a communication network, a visual display of a chat interface on the client device to facilitate a virtual chat communication session between the user and a virtual support agent of the financial institution; receiving, by the one or more financial institution servers from the client device contemporaneously with the virtual chat communication session, a command to receive a copy of an electronic file of an entire transcript associated with a previous virtual chat communication session conducted temporally before the virtual chat communication session; and transmitting, by the one or more financial institution servers in response to the command, a copy of the electronic file to the client device.

In accordance with one or more embodiments set forth, illustrated, and described herein, a computer-implemented method may comprise one or more of the following: causing, by one or more financial institution servers associated with a financial institution during execution of a mobile application or desktop application associated with the financial institution by a client device of a user over a communication network, a visual display of a chat interface on the client device to facilitate a virtual chat communication session between the user and a virtual support agent of the financial institution; receiving, by the one or more financial institution servers from the client device contemporaneously with the virtual chat communication session, a command to receive a copy of an electronic file of an entire transcript associated with a previous virtual chat communication session conducted temporally before the virtual chat communication session; receiving, by the one or more financial institution servers from the client device, a command to terminate the virtual chat communication session; and transmitting, by the one or more financial institution servers in response to the command to terminate, a copy of the electronic file to the client device.

In accordance with one or more embodiments set forth, illustrated, and described herein, a computer-implemented method may comprise one or more of the following: causing, by one or more financial institution servers associated with a financial institution during execution of a mobile application or desktop application associated with the financial institution by a client device of a user over a communication network, a visual display of a chat interface on the client device to facilitate a virtual chat communication session between the user and a virtual support agent of the financial institution; receiving, by the one or more financial institution servers from the client device contemporaneously with the virtual chat communication session, a command to receive a copy of an electronic file of selective portions of a transcript associated with a previous virtual chat communication session conducted temporally before the virtual chat communication session; and transmitting, by the one or more financial institution servers in response to the command, a copy of the electronic file to the client device.

In accordance with one or more embodiments set forth, illustrated, and described herein, a computer-implemented method may comprise one or more of the following: causing, by one or more financial institution servers associated with a financial institution during execution of a mobile application or desktop application associated with the financial institution by a client device of a user over a communication network, a visual display of a chat interface on the client device to facilitate a virtual chat communication session between the user and a virtual support agent of the financial institution; receiving, by the one or more financial institution servers from the client device contemporaneously with the virtual chat communication session, a command to receive a copy of an electronic file of selective portions of a transcript associated with a previous virtual chat communication session conducted temporally before the virtual chat communication session; receiving, by the one or more financial institution servers from the client device, a command to terminate the virtual chat communication session; and transmitting, by the one or more financial institution servers in response to the command to terminate, a copy of the electronic file to the client device.

In accordance with each respective computer-implemented method, further comprising executing, by the one or more financial institution servers temporally before transmitting the electronic file to the client device and in response to the command, encryption of the electronic file(s).

In accordance with each respective computer-implemented method, each command comprises a verbal command.

In accordance with each respective computer-implemented method, further comprising executing, by the one or more financial institution servers, natural language processing (NLP) of each verbal command.

In accordance with each respective computer-implemented method, each command comprises a textual command.

In accordance with each respective computer-implemented method, further comprising executing, by the one or more financial institution servers, natural language processing (NLP) of each textual command.

In accordance with each respective computer-implemented method, further comprising executing, by the one or more financial institution servers in response to the command to receive the copy of the electronic file of the transcript associated with a previous virtual chat communication session, a search of a storage location for the electronic file.

In accordance with each respective computer-implemented method, the search of the storage location for the electronic file is based on a time stamp associated with the previous virtual chat communication session.

In accordance with each respective computer-implemented method, the search of the storage location for the electronic file is based on a one or more keywords associated with the previous virtual chat communication session.

In accordance with each respective computer-implemented method, further comprising executing, by the one or more financial institution servers in response to the command to receive the copy of the electronic file of selective portions of the transcript associated with a previous virtual chat communication session, a search of a storage location for the electronic file for the selective portions of the transcript.

In accordance with each respective computer-implemented method, the search of the storage location for the electronic file is based on a time stamp associated with the selective portions of the transcript.

In accordance with each respective computer-implemented method, the search of the storage location for the electronic file is based on a one or more keywords associated with the selective portions of the transcript.

In accordance with each respective computer-implemented method, the previous virtual chat communication session is identified by the user via a time stamp associated therewith.

In accordance with each respective computer-implemented method, further comprising transmitting, by the one or more financial institution servers, in response to transmitting the electronic file of the transcript associated with the previous virtual chat communication session, an electronic notification of the transmission.

In accordance with each respective computer-implemented method, the electronic notification includes a time stamp indicating when the deletion was completed.

In accordance with each respective apparatus, the electronic notification comprises a text message.

In accordance with each respective computer-implemented method, the electronic notification comprises a chat message in a chat window associated with the virtual chat communication session.

In accordance with each respective computer-implemented method, further comprising enabling, by the one or more financial institution servers in response to transmitting the electronic file to the client device, a visual display of a graphical user interface (GUI) on a user interface of the client device, the GUI comprising pop-up notification of the transmission.

In accordance with each respective computer-implemented method, the pop-up notification includes a time stamp indicating when the transmission was completed.

### DRAWINGS

The various advantages of the exemplary embodiments will become apparent to one skilled in the art by reading the following specification and appended claims, and by referencing the following drawings, in which:

FIG. 1 illustrates a communication environment, in accordance with one or more embodiments set forth and described herein.

FIG. 2 illustrates a block diagram of the first client device of FIG. 1.

FIG. 3 illustrates a block diagram of the second client device of FIG. 1.

FIG. 4 illustrates a block diagram of the one or more financial institution servers of FIG. 1.

FIGS. 5 through 8 respectively illustrate a virtual chat communication session between a user and a virtual support agent, in accordance with one or more embodiments set forth and described herein.

FIGS. 9 through 16 respectively illustrate a computer-implemented method, in accordance with one or more embodiments set forth and described herein.

### DESCRIPTION

Hereinbelow are example definitions that are provided only for illustrative purposes in this disclosure, and should not be construed to limit the scope of the one or more embodiments disclosed herein in any manner. Some terms are defined below for purposes of clarity. These terms are not rigidly restricted to these definitions. This disclosure contemplates that these terms and other terms may also be defined by their use in the context of this description.

As used herein, “application” relates to software used on a computer (usually by a client and/or client device and can be applications that are targeted or supported by specific classes of machine, such as a mobile application, desktop application, tablet application, and/or enterprise application (e.g., client device application(s) on a client device). Applications may be separated into applications which reside on a client device (e.g., VPN, PowerPoint, Excel) and cloud applications which may reside in the cloud (e.g., Gmail, GitHub). Cloud applications may correspond to applications on the client device or may be other types such as social media applications (e.g., Facebook).

As used herein, “artificial intelligence (AI)” relates to one or more computer system operable to perform one or more tasks that normally require human intelligence, such as visual perception, speech recognition, decision-making, and translation between languages.

As used herein, “machine learning” relates to an application of Al that provides computer systems the ability to automatically learn and improve from data and experience without being explicitly programmed.

As used herein, “computer” relates to a single computer or to a system of interacting computers. A computer is a combination of a hardware system, a software operating system and perhaps one or more software application programs. Examples of a computer include without limitation a personal computer (PC), laptop computer, a smart phone, a cell phone, or a wireless tablet.

As used herein, “client device” relates to any device associated with a user, including personal computers, laptops, tablets, and/or mobile smartphones.

As used herein, “modules” relates to either software modules (e.g., code embodied on a machine-readable medium or in a transmission signal) or hardware modules. Certain embodiments are described herein as including logic or a number of components, modules, or mechanisms. A “hardware module” (or just “hardware”) as used herein is a tangible unit capable of performing certain operations and may be configured or arranged in a certain physical manner. In various example embodiments, one or more computer systems (e.g., a standalone computer system, a client computer system, or a server computer system) or one or more hardware modules of a computer system (e.g., a processor or a group of processors) may be configured by software (e.g., an application or application portion) as a hardware module that operates to perform certain operations as described herein. In some embodiments, a hardware module may be implemented mechanically, electronically, or any suitable combination thereof. For example, a hardware module may include dedicated circuitry or logic that is permanently configured to perform certain operations. For example, a hardware module may be a special-purpose processor, such as an FPGA or an ASIC. A hardware module may also include programmable logic or circuitry that is temporarily configured by software to perform certain operations. A hardware module may include software encompassed within a general-purpose processor or other programmable processor. It will be appreciated that the decision to implement a hardware module mechanically, in dedicated and permanently configured circuitry, or in temporarily configured circuitry (e.g., configured by software) may be driven by cost and time considerations. Accordingly, the phrase “hardware module” should be understood to encompass a tangible entity, be that an entity that is physically constructed, permanently configured (e.g., hardwired), or temporarily configured (e.g., programmed) to operate in a certain manner or to perform certain operations described herein. As used herein, “hardware-implemented module” refers to a hardware module. Considering embodiments in which hardware modules are temporarily configured (e.g., programmed), each of the hardware modules need not be configured or instantiated at any one instance in time. For example, where a hardware module comprises a general-purpose processor configured by software to become a special-purpose processor, the general-purpose processor may be configured as respectively different special-purpose processors (e.g., comprising different hardware modules) at different times. Software may accordingly configure a processor, for example, to constitute a particular hardware module at one instance of time and to constitute a different hardware module at a different instance of time. Hardware modules can provide information to, and receive information from, other hardware modules. Accordingly, the described hardware modules may be regarded as being communicatively coupled. Where multiple hardware modules exist contemporaneously, communications may be achieved through signal transmission (e.g., over appropriate circuits and buses) between or among two or more of the hardware modules. In embodiments in which multiple hardware modules are configured or instantiated at different times, communications between such hardware modules may be achieved, for example, through the storage and retrieval of information in memory structures to which the multiple hardware modules have access.

As used herein, “network” or “networks” relates to any combination of electronic communication networks, including without limitation the Internet, a local area network (LAN), a wide area network, a wireless network, and a cellular network (e.g., 4G, 5G).

As used herein, “processes” or “methods” are presented in terms of processes (or methods) or symbolic representations of operations on data stored as bits or binary digital signals within a machine memory (e.g., a computer memory). These processes or symbolic representations are examples of techniques used by those of ordinary skill in the data processing arts to convey the substance of their work to others skilled in the art. As used herein, a “process” is a self-consistent sequence of operations or similar processing leading to a desired result. In this context, processes and operations involve physical manipulation of physical quantities. Typically, but not necessarily, such quantities may take the form of electrical, magnetic, or optical signals capable of being stored, accessed, transferred, combined, compared, or otherwise manipulated by a machine. It is convenient at times, principally for reasons of common usage, to refer to such signals using words such as “data,” “content,” “bits,” “values,” “elements,” “symbols,” “characters,” “terms,” “numbers,” “numerals,” or the like. Unless specifically stated otherwise, discussions herein using words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or any suitable combination thereof), registers, or other machine components that receive, store, transmit, or display information.

As used herein, “processor-Implemented module” relates to a hardware module implemented using one or more processors. The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions described herein.

As used herein, “server” relates to a server computer or group of computers that acts to provide a service for a certain function or access to a network resource. A server may be a physical server, a hosted server in a virtual environment, or software code running on a platform.

As used herein, “service” or “application” relates to an online server (or set of servers), and can refer to a web site and/or web application.

As used herein, “software” relates to a set of instructions and associated documentations that tells a computer what to do or how to perform a task. Software includes all different software programs on a computer, such as applications and the operating system. A software application could be written in substantially any suitable programming language, which could easily be selected by one of ordinary skill in the art. The programming language chosen should be compatible with the computer by which the software application is to be executed and, in particular, with the operating system of that computer. Examples of suitable programming languages include without limitation Object Pascal, C, C++, CGI, Java, and Java Scripts. Further, the functions of some embodiments, when described as a series of steps for a method, could be implemented as a series of software instructions for being operated by a processor, such that the embodiments could be implemented as software, hardware, or a combination thereof.

As used herein, “sensor” relates to any device, component and/or system that can perform one or more of detecting, determining, assessing, monitoring, measuring, quantifying, and sensing something.

As used herein, “real-time” relates to a level of processing responsiveness that a user, module, or system senses as sufficiently immediate for a particular process or determination to be made, or that enables the processor to keep up with some external process.

As used herein, “user” relates to a consumer, machine entity, and/or requesting party, and may be human or machine.

In accordance with one or more embodiments set forth, illustrated, and described herein, a chat support platform is provided for a client device of a user having one or more financial accounts residing at one or more financial institution servers of a financial institution. The chat support platform facilitates a more enhanced chat experience by transmitting, on command by the user during a virtual chat communication session between a virtual support agent of a financial institution and the user on a client device executing a mobile application or desktop application associated with the financial institution over a communication network, an electronic file (e.g., PDF, HTML, HTM, XLS, XLSX, txt, audio, etc.) of the transcript associated with the virtual chat communication session. The electronic file may contain all or selective portions of the transcript associated with the virtual chat communication session. The user may, in turn, save the electronic file locally to a client device for later use. The electronic file may be encrypted and/or password protected before transmission to the client device. Alternatively or additionally, should any data and information within the transcript be considered personally identifiable information (PII) of the user, such data and information may be redacted automatically or by user command.

For example, during the virtual chat communication session, the user may request, via a client device, wiring instructions on transmitting an international wire. Contemporaneously with the virtual chat communication session, the user may command, via the client device, a copy of the electronic file containing the entire transcript associated with the virtual chat communication session. Alternatively, the user may command a copy of the electronic file contain only the portion(s) of the transcript containing the information pertaining to wiring instructions on transmitting an international wire. In that way, the user may save the electronic file locally to the client device or another client device for later use, e.g., when transmitting an international wire.

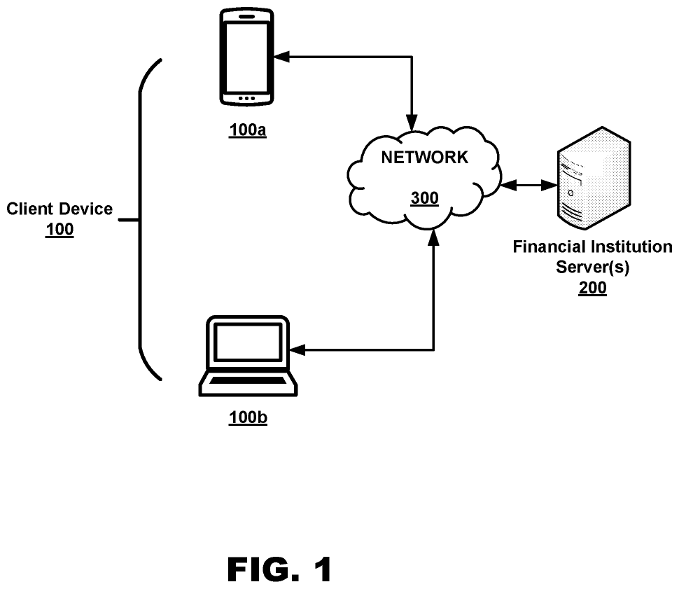

Turning to the figures, in which FIG. 1 illustrates a communication environment that facilitates communications between a user and a financial institution. A client device 100 of a user (financial account holder), operating in the communication environment, facilitates user access to and user management of one or more financial accounts residing at one or more financial institution servers 200 of the financial institution. The communication environment includes the client device 100, the one or more financial institution servers 200, and a communication network 300 through which communication is facilitated between the client device 100 and the one or more financial institution servers 200.

In accordance with one or more embodiments set forth, described, and/or illustrated herein, the client device 100 comprises a computing device, including but not limited to a desktop computer, a laptop computer, a smart phone, a handheld personal computer, a workstation, a game console, a cellular phone, a mobile device, a personal computing device, a wearable electronic device, a smartwatch, smart eyewear, a tablet computer, a convertible tablet computer, or any other electronic, microelectronic, or micro-electromechanical device for processing and communicating data. This disclosure contemplates the client device 100 comprising any form of electronic device that optimizes or otherwise transforms the performance and functionality of the one or more embodiments in a manner that falls within the spirit and scope of the principles of this disclosure.

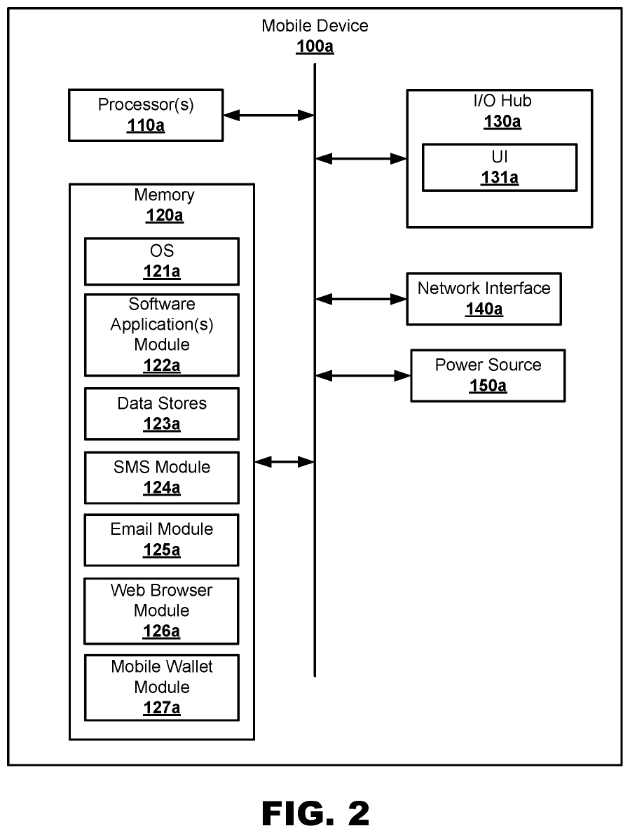

In the illustrated example embodiment of FIG. 2, the client device 100 comprises a mobile device 100a. Some of the possible operational elements of the mobile device 100a are illustrated in FIG. 2 and will now be described herein. It will be understood that it is not necessary for the mobile device 100a to have all the elements illustrated in FIG. 2. For example, the mobile device 100a may have any combination of the various elements illustrated in FIG. 2. Moreover, the mobile device 100a may have additional elements to those illustrated in FIG. 2.

The mobile device 100a includes one or more processors 110a, a non-transitory memory 120a operatively coupled to the one or more processors 110a, an I/O hub 130a, a network interface 140a, and a power source 150a.

The memory 120a comprises a set of instructions of computer-executable program code. The set of instructions are executable by the one or more processors 110a to cause execution of an operating system 121a and one or more software applications of a software application module 122a that reside in the memory 120a. The one or more software applications residing in the memory 120a includes, but is not limited to, a financial institution application that is associated with the financial institution. The financial institution application comprises a mobile application that facilitates establishment of a secure connection between the mobile device 100a and the one or more financial institution servers 200. The one or more processors 110a are operable to execute the mobile application to facilitate user access to the one or more financial accounts and user management of the one or more financial accounts.

The memory 120a also includes one or more data stores 123a that are operable to store one or more types of data. The mobile device 100a may include one or more interfaces that facilitate one or more systems or modules thereof to transform, manage, retrieve, modify, add, or delete, the data residing in the data stores 123a. The one or more data stores 123a may comprise volatile and/or non-volatile memory. Examples of suitable data stores 123a include, but are not limited to RAM (Random Access Memory), flash memory, ROM (Read Only Memory), PROM (Programmable Read-Only Memory), EPROM (Erasable Programmable Read-Only Memory), EEPROM (Electrically Erasable Programmable Read-Only Memory), registers, magnetic disks, optical disks, hard drives, or any other suitable non-transitory storage medium, or any combination thereof. The one or more data stores 123a may be a component of the one or more processors 110a or alternatively, may be operatively connected to the one or more processors 110a for use thereby. As set forth, described, and/or illustrated herein, “operatively connected” may include direct or indirect connections, including connections without direct physical contact.

The memory 120a also includes an SMS module 124a operable to facilitate user transmission and receipt of text messages via the mobile device 100a though the network 300. In one example embodiment, the user may receive text messages from the financial institution that are associated with the user access and the user management of the one or more financial accounts. An email module 125a is operable to facilitate user transmission and receipt of email messages via the mobile device 100a through the network 300. In one example embodiment, the user may receive email messages from the financial institution that are associated with the user access and the user management of the one or more financial accounts. The user may utilize a web browser module 126a that is operable to facilitate user access to one or more websites associated with the financial institution through the network 300. A digital wallet module 127a facilitates the generation of one or more digital wallets associated with the one or more financial accounts.

In accordance with one or more embodiments set forth, described, and/or illustrated herein, the mobile device 100a includes an I/O hub 130a operatively connected to other systems and subsystems of the mobile device 100a. The I/O system 130a may include one or more of an input interface, an output interface, and a network controller to facilitate communications between the mobile device 100a and the one or more financial institution servers 200. The input interface and the output interface may be integrated as a single, unitary user interface 131a, or alternatively, be separate as independent interfaces that are operatively connected.

As used herein, the input interface is defined as any device, software, component, system, element, or arrangement or groups thereof that enable information and/or data to be entered as input commands by a user in a manner that directs the one or more processors 110a to execute instructions. The input interface may comprise a user interface (UI), a graphical user interface (GUI), such as, for example, a display, human-machine interface (HMI), or the like. Embodiments, however, are not limited thereto, and thus, this disclosure contemplates the input interface comprising a keypad, touch screen, multi-touch screen, button, joystick, mouse, trackball, microphone and/or combinations thereof.

As used herein, the output interface is defined as any device, software, component, system, element or arrangement or groups thereof that enable information/data to be presented to a user. The output interface may comprise one or more of a visual display or an audio display, including, but not limited to, a microphone, earphone, and/or speaker. One or more components of the mobile device 100a may serve as both a component of the input interface and a component of the output interface.

The mobile device 100a also includes a network interface 140a operable to facilitate connection to the network 300. The mobile device 100a further includes a power source 150a that comprises a wired powered source, a wireless power source, a replaceable battery source, or a rechargeable battery source.

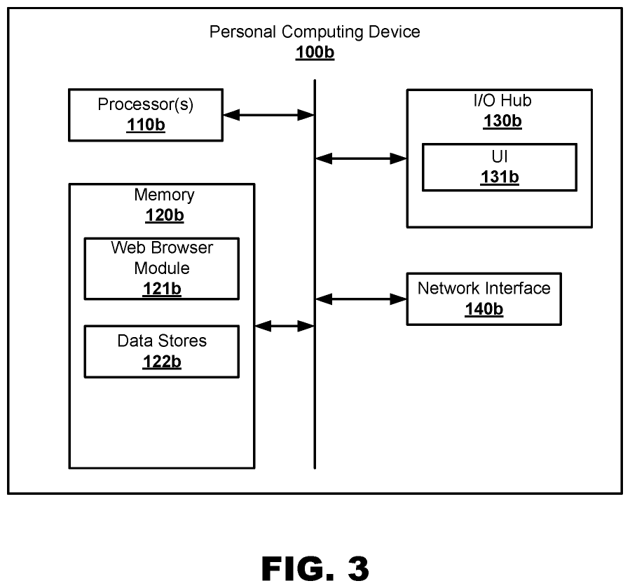

In the illustrated example embodiment of FIG. 3, the client device 100 comprises a personal computing device 100b. Some of the possible operational elements of the personal computing device 100b are illustrated in FIG. 3 and will now be described herein. It will be understood that it is not necessary for the personal computing device 100b to have all the elements illustrated in FIG. 3. For example, the personal computing device 100b may have any combination of the various elements illustrated in FIG. 3. Moreover, the personal computing device 100b may have additional elements to those illustrated in FIG. 3.

The personal computing device 100b includes one or more processors 110b, a non-transitory memory 120b operatively coupled to the one or more processors 110A, an I/O hub 130b, and a network interface 140b.

The memory 120b comprises a set of instructions of computer-executable program code. The set of instructions are executable by the one or more processors 110b to cause control of the web browser module 121b in a manner that facilitates user access to a web browser having one or more websites associated with the financial institution through the network 300.

The memory 120b also includes one or more data stores 122b that are operable to store one or more types of data. The personal computing device 100b may include one or more interfaces that facilitate one or more systems or modules thereof to transform, manage, retrieve, modify, add, or delete, the data residing in the data stores 122b. The one or more data stores 122b may comprise volatile and/or non-volatile memory. Examples of suitable data stores 122b include, but are not limited to RAM (Random Access Memory), flash memory, ROM (Read Only Memory), PROM (Programmable Read-Only Memory), EPROM (Erasable Programmable Read-Only Memory), EEPROM (Electrically Erasable Programmable Read-Only Memory), registers, magnetic disks, optical disks, hard drives, or any other suitable non-transitory storage medium, or any combination thereof. The one or more data stores 122b may be a component of the one or more processors 110b, or alternatively, may be operatively connected to the one or more processors 110b for use thereby. As set forth, described, and/or illustrated herein, “operatively connected” may include direct or indirect connections, including connections without direct physical contact.

In accordance with one or more embodiments set forth, described, and/or illustrated herein, “processor” means any component or group of components that are operable to execute any of the processes described herein or any form of instructions to carry out such processes or cause such processes to be performed. The one or more processors 100b may be implemented with one or more general-purpose and/or one or more special-purpose processors. Examples of suitable processors include graphics processors, microprocessors, microcontrollers, DSP processors, and other circuitry that may execute software. Further examples of suitable processors include, but are not limited to, a central processing unit (CPU), an array processor, a vector processor, a digital signal processor (DSP), a field-programmable gate array (FPGA), a programmable logic array (PLA), an application specific integrated circuit (ASIC), programmable logic circuitry, and a controller. The one or more processors 110b may comprise at least one hardware circuit (e.g., an integrated circuit) operable to carry out instructions contained in program code. In embodiments in which there is a plurality of processors, such processors may work independently from each other, or one or more processors may work in combination with each other.

In accordance with one or more embodiments set forth, described, and/or illustrated herein, the personal computing device 100b includes an I/O hub 130b operatively connected to other systems and subsystems of the personal computing device 100b. The I/O system 130b may include one or more of an input interface, an output interface, and a network controller to facilitate communications between the personal computing device 100b and the one or more financial institution servers 200. The input interface and the output interface may be integrated as a single, unitary user interface 131b, or alternatively, be separate as independent interfaces that are operatively connected.

As used herein, the input interface is defined as any device, software, component, system, element, or arrangement or groups thereof that enable information and/or data to be entered as input commands by a user in a manner that directs the one or more processors 110b to execute instructions. The input interface may comprise a user interface (UI), a graphical user interface (GUI), such as, for example, a display, human-machine interface (HMI), or the like. Embodiments, however, are not limited thereto, and thus, this disclosure contemplates the input interface comprising a keypad, touch screen, multi-touch screen, button, joystick, mouse, trackball, microphone and/or combinations thereof.

As used herein, the output interface is defined as any device, software, component, system, element or arrangement or groups thereof that enable information/data to be presented to a user. The output interface may comprise one or more of a visual display or an audio display, including, but not limited to, a microphone, earphone, and/or speaker. One or more components of the personal computing device 100b may serve as both a component of the input interface and a component of the output interface.

The personal computing device 100b also includes a network interface 140b operable to facilitate connection to the network 300.

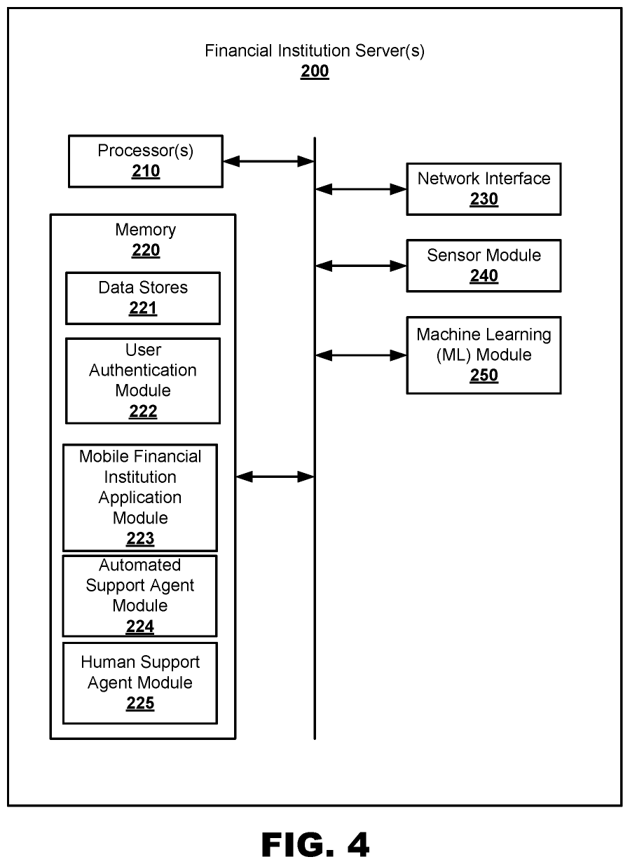

As illustrated in FIG. 4, the one or more financial institution servers 200 includes one or more processors 210, a non-transitory memory 220 operatively coupled to the one or more processors 210, a network interface 230, a sensor module 240, and a machine learning (ML) module 250. Some of the possible operational elements of each server in the one or more financial institution servers 200 are illustrated in FIG. 4 and will now be described herein. It will be understood that it is not necessary for each server in the one or more financial institution servers 200 to have all the elements illustrated in FIG. 4. For example, each server in the one or more financial institution servers 200 may have any combination of the various elements illustrated in FIG. 4. Moreover, each server in the one or more financial institution servers 200 may have additional elements to those illustrated in FIG. 4.

The one or more financial institution servers 200 may be controlled by a system manager (or policy manager) of the financial institution.

In accordance with one or more embodiments set forth, described, and/or illustrated herein, the one or more financial institution servers 200 may comprise a computing device, including but not limited to a server computer, a desktop computer, a laptop computer, a smart phone, a handheld personal computer, a workstation, a game console, a cellular phone, a mobile device, a personal computing device, a wearable electronic device, a smartwatch, smart eyewear, a tablet computer, a convertible tablet computer, or any other electronic, microelectronic, or micro-electromechanical device for processing and communicating data. This disclosure contemplates the one or more financial institution servers 200 comprising any form of electronic device that optimizes or otherwise transforms the performance and functionality of the one or more embodiments in a manner that falls within the spirit and scope of the principles of this disclosure.

The memory 220 comprises a set of instructions of computer-executable program code. The set of instructions are executable by the one or more processors 210 in manner that facilitates control of a user authentication module 222, a mobile financial institution application module 223 having one or more mobile financial institution applications that reside in the memory 220, an automated support agent module 224, and a human support agent module 225. In accordance with one or more embodiments set forth, described, and/or illustrated herein, the one or more financial institution servers 200 may individually or collectively execute the instructions to perform any one or more of the methodologies set forth, described, and illustrated herein. The virtual support agent module 224 may execute natural language processing (NLP) based on natural language input by the user via the client device 100 in response to one or more probing questions presented by the automated virtual support agent.

The memory 220 also includes one or more data stores 221 that are operable to store one or more types of data, including but not limited to, user account data, user authentication data, sensor data, etc. For instance, the one or more data stores 123a may comprise a storage location on which one or more electronic files of the transcripts associated with virtual chat communications reside. The one or more data stores 221 may comprise volatile and/or non-volatile memory. Examples of suitable data stores 221 include, but are not limited to RAM (Random Access Memory), flash memory,

ROM (Read Only Memory), PROM (Programmable Read-Only Memory), EPROM (Erasable Programmable Read-Only Memory), EEPROM (Electrically Erasable Programmable Read-Only Memory), registers, magnetic disks, optical disks, hard drives, or any other suitable non-transitory storage medium, or any combination thereof. The one or more data stores 221 may be a component of the one or more processors 210, or alternatively, may be operatively connected to the one or more processors 210 for use thereby. As set forth, described, and/or illustrated herein, “operatively connected” may include direct or indirect connections, including connections without direct physical contact.

The memory 220 may include a single machine-readable medium, or a plurality of media (e.g., a centralized or distributed database, or associated caches and servers) operable to store the instructions. The term “machine-readable medium” shall also be taken to include any medium, or combination of multiple media, that is capable of storing instructions (e.g., software) for execution by a server (e.g., server), such that the instructions, when executed by the one or more processors 210, cause the one or more financial institution servers 200 to perform any one or more of the methodologies set forth, described, and illustrated herein. Accordingly, a “machine-readable medium” refers to a single storage apparatus or device, as well as “cloud-based” storage systems or storage networks that include multiple storage apparatus or devices. The term “machine-readable medium” shall accordingly be taken to include, but not be limited to, one or more data repositories in the form of a solid-state memory, an optical medium, a magnetic medium, or any suitable combination thereof.

The computer-executable program code may instruct the one or more processors 210 to cause the user authentication module 221 to authenticate a user in order to gain user access to the one or more financial accounts. The user authentication module 221 may be caused to request user input user data or user identification that include, but are not limited to, user identity (e.g., username), a user passcode, a cookie, user biometric data, a private key, a token, and/or another suitable authentication data or information.

The computer-executable program code may instruct the one or more processors 210 to execute certain logic, data-processing, and data-storing functions of the one or more financial institution servers 200, in addition to certain communication functions of the one or more financial institution servers 200. The one or more mobile financial institution applications of the mobile financial institution application module 222 are operable to communicate with the client device 100 in a manner which facilitates user access to the one or more financial accounts in addition to user management of the one or more financial accounts based on successful user authentication.

The sensor module 240 is operable, at least during execution of the mobile application by the client device 100, to dynamically detect, determine, assess, monitor, measure, quantify, and/or sense information about the client device 100. The sensor module 240 may be operable to detect, determine, assess, monitor, measure, quantify and/or sense in real-time. The sensor module 240 may be operable to detect, determine, assess, monitor, measure, quantify, and/or sense geographic location information about the geographic location of the client device 100.

The ML module 250 may include one or more ML algorithms to train one or more machine learning models of the one or more financial institution servers 200 based on chat data, human support agent data, user financial data, and/or information resided in the memory 220. The ML algorithms may include one or more of a linear regression algorithm, a logical regression algorithm, or a combination of different algorithms. A neural network may also be used to train the system based on the received data. The ML module 250 may analyze the received data and/or information, and transform the data and/or information in a manner which provides enhanced communication between the client device 100 and the one or more financial institution servers 200, while also enhancing user access and management of the one or more financial accounts. The data and/or information may also be up-linked to other systems and modules in the one or more financial institution servers 200 for further processing to discover additional information that may be used to enhance the understanding of the information.

In accordance with one or more embodiments set forth, described, and/or illustrated herein, the network 300 may comprise a wireless network, a wired network, or any suitable combination thereof. For example, the network 300 is operable to support connectivity using any protocol or technology, including, but not limited to wireless cellular, wireless broadband, wireless local area network (WLAN), wireless personal area network (WPAN), wireless short distance communication, Global System for Mobile Communication (GSM), or any other suitable wired or wireless network operable to transmit and receive a data signal.

In accordance with one or more embodiments set forth, described, and/or illustrated herein, a user may, via the client device 100, execute a mobile application or a desktop application associated with the financial institution over the communication network 300.

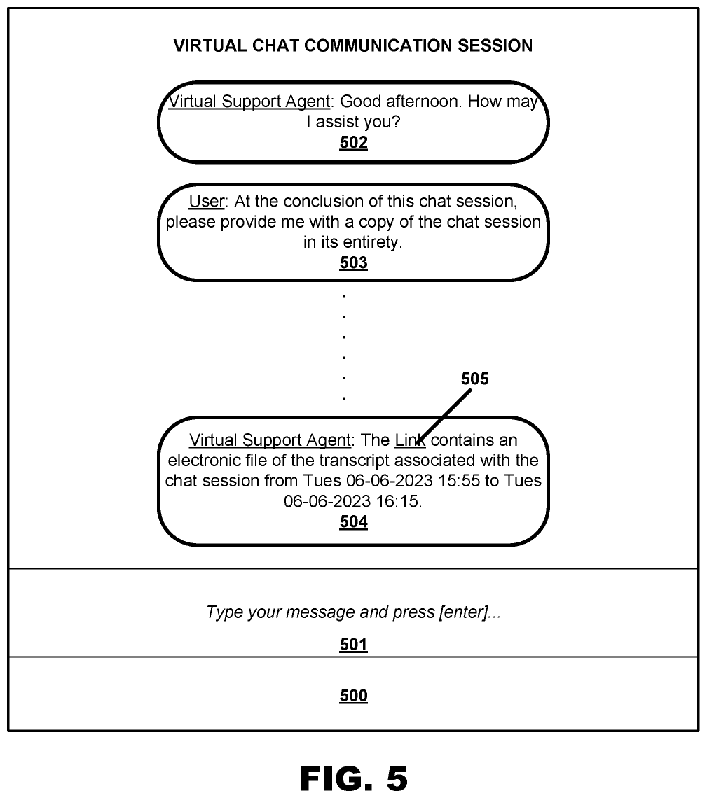

As illustrated in FIG. 5, upon a user launching the mobile application or the desktop application on the client device 100, and being authenticated by the user authentication module 221, the computer-executable program code may instruct the one or more processors 210 to cause a display of a graphical user interface (GUI) on the user interface 131a, 131b of the client device 100. The GUI comprises a chat interface 500 that facilitates a virtual chat communication session in natural language communicated verbally and/or textually with a virtual support agent (e.g., an automated virtual support agent or a human virtual support agent). The automated virtual support agent may comprise a chatbot. The user may input text messages via a chat window 501 that are to be processed by the one or more financial institution servers 200 (e.g., via one or more of the automated support agent module 224, the human support agent module 225, and the ML module 250). The virtual chat communication session includes a plurality of chat messages 502-504 visually displayed in chat bubbles between the user and the virtual support agent. The chat messages may be in verbal form or textual form.

During the virtual chat communication session, the user, via the client device 100, may transmit a chat message 503 in the form of a request or command (e.g., a verbal command or a textual command) to receive a copy of an electronic file of a transcript associated with the currently-active virtual chat communication session.

In response to the request or command, the computer-executable program code may instruct the one or more processors 210 to execute natural language processing (NLP) of the request or command.

In response to the request or command and based on the NLP, the computer-executable program code may instruct the one or more processors 210 to detect termination of the current virtual chat communication session based on one or more events. The one or more events include, but are not limited to, a user textual request or command, a user verbal request or command, a user engaging a user-engageable icon on the chat interface 500, etc.

In response to the request or command and the detection of the termination of the current virtual chat communication session, the computer-executable program code may instruct the one or more processors 210 to transmit the electronic file 505 of the transcript associated with the virtual chat communication session to the client device 100. The electronic file 505 may have one or more of the following formats: PDF, HTML, HTM, XLS, XLSX, txt, audio, etc. The electronic file 505 may be encrypted and/or password protected before transmission to the client device. Alternatively or additionally, should any data and information within the transcript be considered personally identifiable information (PII) of the user, such data and information may be redacted automatically or by user command. This advantageously enables the user to save the electronic file 505 locally to the client device 100 (or another client device) for later use.

In accordance with one or more embodiments, the user may transmit, via the client device 100, a request for command for a specific type of format for the electronic file 505 to be transmitted to the client device 100. In response to the request or command, the computer-executable program code may instruct the one or more processors 210 to transmit the electronic file 505 having the specific format requested by the user.

In response to transmitting the electronic file 505, the computer-executable program code may instruct the one or more processors 210 to transmit, in response to the deletion of the data and information, a notification of the electronic file 505 to the client device 100. The notification may comprise an electronic notification that includes a time stamp indicating when the electronic file 505 was transmitted. The electronic notification can comprise one or more of a text message, an email, and a chat message 504 associated with the virtual chat communication session. The notification may comprise a graphical user interface (GUI) visually displayed on the user interface 131a, 131b of the client device 100. The GUI may comprise a pop-up notification of the transmission of the electronic file 505. The pop-up notification may include a time stamp indicating when the electronic file 505 was transmitted.

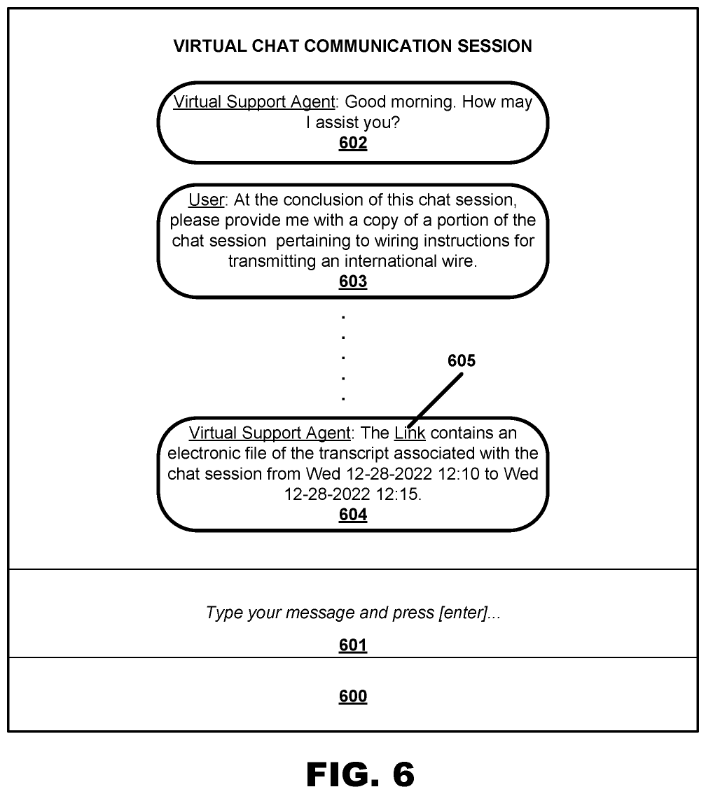

As illustrated in FIG. 6, upon a user launching the mobile application or the desktop application on the client device 100, and being authenticated by the user authentication module 221, the computer-executable program code may instruct the one or more processors 210 to cause a display of a graphical user interface (GUI) on the user interface 131a, 131b of the client device 100. The GUI comprises a chat interface 600 that facilitates a virtual chat communication session in natural language communicated verbally and/or textually with a virtual support agent (e.g., an automated virtual support agent or a human virtual support agent). The automated virtual support agent may comprise a chatbot. The user may input text messages via a chat window 601 that are to be processed by the one or more financial institution servers 200 (e.g., via one or more of the automated support agent module 224, the human support agent module 225, and the ML module 250). The virtual chat communication session includes a plurality of chat messages 602-604 visually displayed in chat bubbles between the user and the virtual support agent. The chat messages may be in verbal form or textual form.

During the virtual chat communication session, the user, via the client device 100, may transmit a chat message 603 in the form of a request or command (e.g., a verbal command or a textual command) to receive a copy of an electronic file of one or more selective portions of a transcript associated with the currently-active virtual chat communication session. The selective portion(s) may be associated with data and information and/or instructions provided by the virtual support agent that enable a user to perform one or more tasks related to one or more user financial accounts maintained by the financial institution.

In response to the request or command, the computer-executable program code may instruct the one or more processors 210 to execute natural language processing (NLP) of the request or command.

In response to the request or command and based on the NLP, the computer-executable program code may instruct the one or more processors 210 to detect termination of the current virtual chat communication session based on one or more events. The one or more events include, but are not limited to, a user textual request or command, a user verbal request or command, a user engaging a user-engageable icon on the chat interface 600, etc.

In response to the request or command and the detection of the termination of the current virtual chat communication session, the computer-executable program code may instruct the one or more processors 210 to execute a search of one or more data stores 221 of the one or more financial institution servers 200 for the one or more selective portions of the transcript associated with the now-terminated virtual chat communication session. The search may be based on a time stamp associated with the one or more selective portions of the transcript, or one or more keywords associated with the one or more selective portions of the transcript. Alternatively, the search may be executed concurrently with the current virtual chat communication session (i.e., not after termination of the current virtual chat communication session).

In response to the search in which the one or more selective portions of the transcript have been found/acquired, the computer-executable program code may instruct the one or more processors 210 to transmit the electronic file 605 of the one or more selective portions of the transcript associated with the virtual chat communication session to the client device 100. The electronic file 605 may have one or more of the following formats: PDF, HTML, HTM, XLS, XLSX, txt, audio, etc. The electronic file 605 may be encrypted and/or password protected before transmission to the client device. Alternatively or additionally, should any data and information within the transcript be considered personally identifiable information (PII) of the user, such data and information may be redacted automatically or by user command. This advantageously enables the user to save the electronic file 605 locally to the client device 100 (or another client device) for later use.

In accordance with one or more embodiments, the user may transmit, via the client device 100, a request for command for a specific type of format for the electronic file 605 to be transmitted to the client device 100. In response to the request or command, the computer-executable program code may instruct the one or more processors 210 to transmit the electronic file 605 having the specific format requested by the user.

In response to transmitting the electronic file 605, the computer-executable program code may instruct the one or more processors 210 to transmit, in response to the deletion of the data and information, a notification of the electronic file 605 to the client device 100. The notification may comprise an electronic notification that includes a time stamp indicating when the electronic file 605 was transmitted. The electronic notification can comprise one or more of a text message, an email, and a chat message 604 associated with the virtual chat communication session. The notification may comprise a graphical user interface (GUI) visually displayed on the user interface 131a, 131b of the client device 100. The GUI may comprise a pop-up notification of the transmission of the electronic file 605. The pop-up notification may include a time stamp indicating when the electronic file 605 was transmitted.

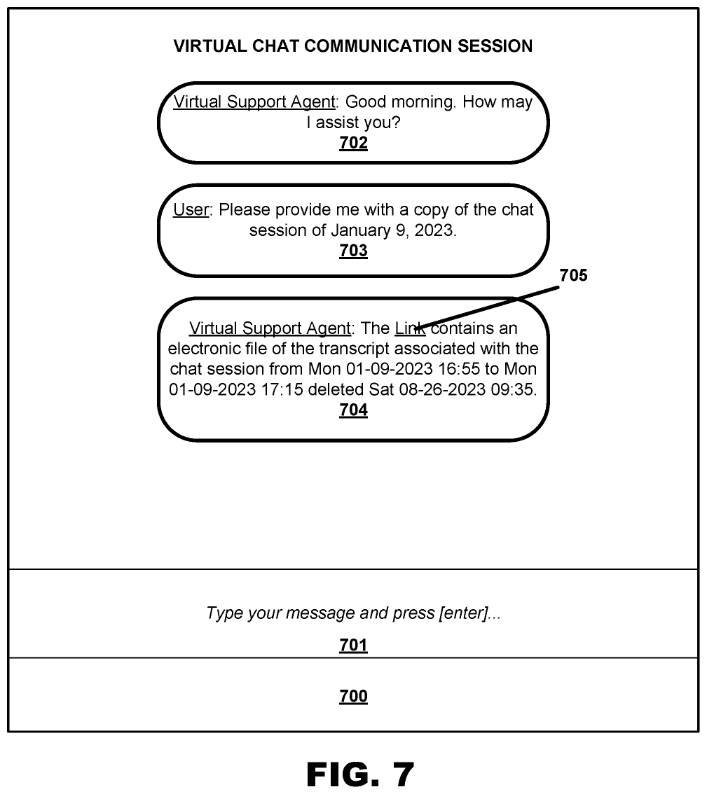

As illustrated in FIG. 7, upon a user launching the mobile application or the desktop application on the client device 100, and being authenticated by the user authentication module 221, the computer-executable program code may instruct the one or more processors 210 to cause a display of a graphical user interface (GUI) on the user interface 131a, 131b of the client device 100. The GUI comprises a chat interface 700 that facilitates a virtual chat communication session in natural language communicated verbally and/or textually with a virtual support agent (e.g., an automated virtual support agent or a human virtual support agent). The automated virtual support agent may comprise a chatbot. The user may input text messages via a chat window 701 that are to be processed by the one or more financial institution servers 200 (e.g., via one or more of the automated support agent module 224, the human support agent module 225, and the ML module 250). The virtual chat communication session includes a plurality of chat messages 702-704 visually displayed in chat bubbles between the user and the virtual support agent. The chat messages may be in verbal form or textual form.

During the virtual chat communication session, the user, via the client device 100, may transmit a chat message 703 in the form of a request or command (e.g., a verbal command or a textual command) to receive a copy of an electronic file of a transcript associated with a previous virtual chat communication session that is stored in memory 220 of the one or more financial institution servers 200.

In response to the request or command, the computer-executable program code may instruct the one or more processors 210 to execute natural language processing (NLP) of the request or command.

In response to the request or command and based on the NLP, the computer-executable program code may instruct the one or more processors 210 to detect termination of the current virtual chat communication session based on one or more events. The one or more events include, but are not limited to, a user textual request or command, a user verbal request or command, a user engaging a user-engageable icon on the chat interface 700, etc.

In response to the request or command and the detection of the termination of the current virtual chat communication session, the computer-executable program code may instruct the one or more processors 210 to execute a search of one or more data stores 221 of the computing device for the transcript (e.g., digital transcript) of the previous virtual chat communication session. The search may be based on a time stamp associated with the previous virtual chat communication session, or a one or more keywords associated with the previous virtual chat communication session. The time stamp associated with the previous virtual chat communication session may be acquired from the user via the client device 100.

In response to the search, the computer-executable program code may instruct the one or more processors 210 to transmit the copy of the electronic file of a transcript associated with the previous virtual chat communication session. The electronic file 705 may have one or more of the following formats: PDF, HTML, HTM, XLS, XLSX, txt, audio, etc. The electronic file 705 may be encrypted and/or password protected before transmission to the client device. Alternatively or additionally, should any data and information within the transcript be considered personally identifiable information (PII) of the user, such data and information may be redacted automatically or by user command. This advantageously enables the user to save the electronic file 705 locally to the client device 100 (or another client device) for later use.

In accordance with one or more embodiments, the user may transmit, via the client device 100, a request for command for a specific type of format for the electronic file 705 to be transmitted to the client device 100. In response to the request or command, the computer-executable program code may instruct the one or more processors 210 to transmit the electronic file 705 having the specific format requested by the user.

In response to transmitting the electronic file 705, the computer-executable program code may instruct the one or more processors 210 to transmit, in response to the deletion of the data and information, a notification of the electronic file 705 to the client device 100. The notification may comprise an electronic notification that includes a time stamp indicating when the electronic file 705 was transmitted. The electronic notification can comprise one or more of a text message, an email, and a chat message 704 associated with the virtual chat communication session. The notification may comprise a graphical user interface (GUI) visually displayed on the user interface 131a, 131b of the client device 100. The GUI may comprise a pop-up notification of the transmission of the electronic file 705. The pop-up notification may include a time stamp indicating when the electronic file 705 was transmitted.

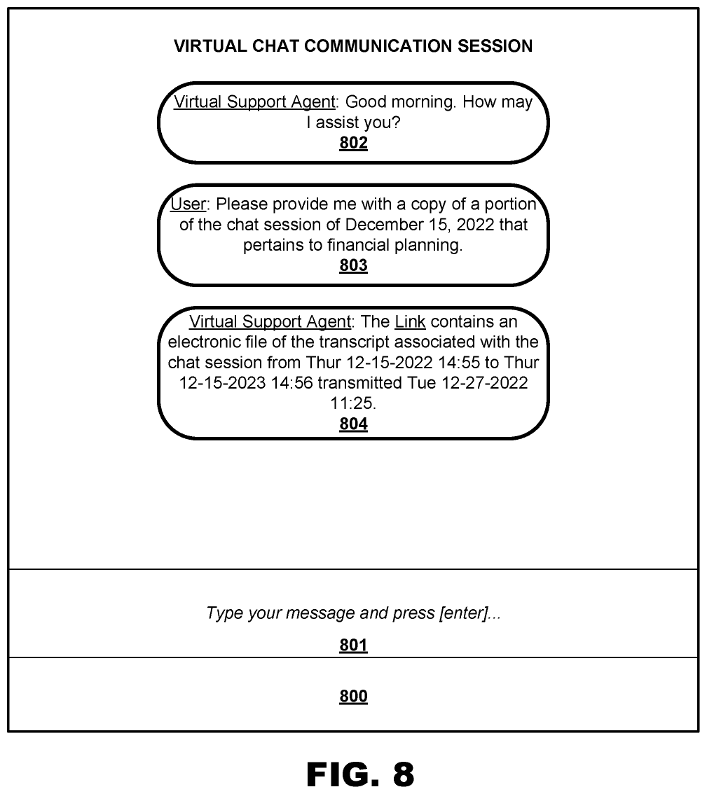

As illustrated in FIG. 8, upon a user launching the mobile application or the desktop application on the client device 100, and being authenticated by the user authentication module 221, the computer-executable program code may instruct the one or more processors 210 to cause a display of a graphical user interface (GUI) on the user interface 131a, 131b of the client device 100. The GUI comprises a chat interface 800 that facilitates a virtual chat communication session in natural language communicated verbally and/or textually with a virtual support agent (e.g., an automated virtual support agent or a human virtual support agent). The automated virtual support agent may comprise a chatbot. The user may input text messages via a chat window 801 that are to be processed by the one or more financial institution servers 200 (e.g., via one or more of the automated support agent module 224, the human support agent module 225, and the ML module 250). The virtual chat communication session includes a plurality of chat messages 802-804 visually displayed in chat bubbles between the user and the virtual support agent. The chat messages may be in verbal form or textual form.

During the virtual chat communication session, the user, via the client device 100, may transmit a chat message 803 in the form of a request or command (e.g., a verbal command or a textual command) to receive a copy of an electronic file of one or more selective portions of the transcript associated with a previous virtual chat communication session that is stored in memory 220 of the one or more financial institution servers 200.

In response to the request or command, the computer-executable program code may instruct the one or more processors 210 to execute natural language processing (NLP) of the request or command.

In response to the request or command and based on the NLP, the computer-executable program code may instruct the one or more processors 210 to detect termination of the current virtual chat communication session based on one or more events. The one or more events include, but are not limited to, a user textual request or command, a user verbal request or command, a user engaging a user-engageable icon on the chat interface 800, etc.

In response to the request or command and the detection of the termination of the current virtual chat communication session, the computer-executable program code may instruct the one or more processors 210 to execute a search of one or more data stores 221 of the computing device for the transcript (e.g., digital transcript) of the previous virtual chat communication session. Alternatively, in response to the request or command and contemporaneously with the virtual chat communication session (i.e., without termination of the current virtual chat communication session), the computer-executable program code may instruct the one or more processors 210 to execute a search of one or more data stores 221 of the computing device for the transcript (e.g., digital transcript) of the previous virtual chat communication session. The search may be based on a time stamp associated with the previous virtual chat communication session, or a one or more keywords associated with the previous virtual chat communication session. The time stamp associated with the previous virtual chat communication session may be acquired from the user via the client device 100.

In response to the search, the computer-executable program code may instruct the one or more processors 210 to transmit the copy of the electronic file of a transcript associated with the previous virtual chat communication session. The electronic file 805 may have one or more of the following formats: PDF, HTML, HTM, XLS, XLSX, txt, audio, etc. The electronic file 805 may be encrypted and/or password protected before transmission to the client device. Alternatively or additionally, should any data and information within the transcript be considered personally identifiable information (PII) of the user, such data and information may be redacted automatically or by user command. This advantageously enables the user to save the electronic file 805 locally to the client device 100 (or another client device) for later use.

In accordance with one or more embodiments, the user may transmit, via the client device 100, a request for command for a specific type of format for the electronic file 805 to be transmitted to the client device 100. In response to the request or command, the computer-executable program code may instruct the one or more processors 210 to transmit the electronic file 805 having the specific format requested by the user.

In response to transmitting the electronic file 805, the computer-executable program code may instruct the one or more processors 210 to transmit, in response to the deletion of the data and information, a notification of the electronic file 805 to the client device 100. The notification may comprise an electronic notification that includes a time stamp indicating when the electronic file 805 was transmitted. The electronic notification can comprise one or more of a text message, an email, and a chat message 804 associated with the virtual chat communication session. The notification may comprise a graphical user interface (GUI) visually displayed on the user interface 131a, 131b of the client device 100. The GUI may comprise a pop-up notification of the transmission of the electronic file 805. The pop-up notification may include a time stamp indicating when the electronic file 805 was transmitted.

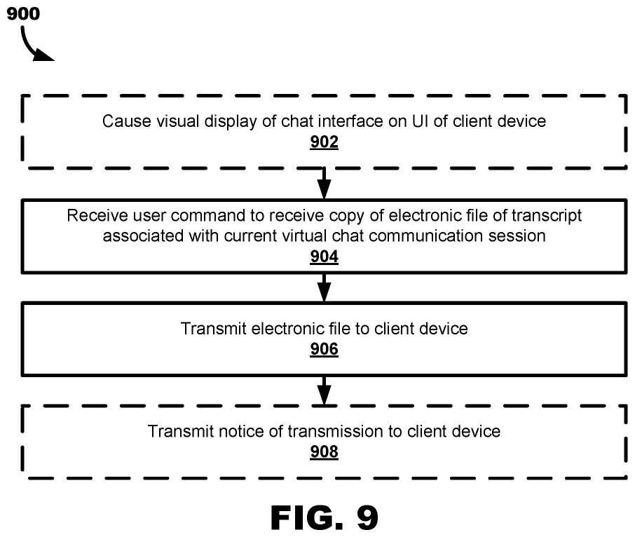

Illustrated examples shown in FIGS. 9 to 16 set forth computer-implemented methods 900, 1000, 1100, 1200, 1300, 1400, 1500, and 1600. In one or more examples, the respective flowcharts of the computer-implemented methods 900, 1000, 1100, 1200, 1300, 1400, 1500, and 1600 may be implemented by the one or more processors 210 of the one or more financial institution servers 200. In particular, the computer-implemented methods 900, 1000, 1100, 1200, 1300, 1400, 1500, and 1600 may be implemented as one or more modules in a set of logic instructions stored in a non-transitory machine- or computer-readable storage medium such as random access memory (RAM), read only memory (ROM), programmable ROM (PROM), firmware, flash memory, etc., in configurable logic such as, for example, programmable logic arrays (PLAs), field programmable gate arrays (FPGAs), complex programmable logic devices (CPLDs), in fixed-functionality hardware logic using circuit technology such as, for example, application specific integrated circuit (ASIC), complementary metal oxide semiconductor (CMOS) or transistor-transistor logic (TTL) technology, or any combination thereof.

In accordance with one or more embodiments set forth, described, and/or illustrated herein, software executed by the one or more financial institution servers 200 provides functionality described or illustrated herein. In particular, software executed by the one or more processors 210 is operable to perform one or more processing blocks of the computer-implemented methods 900, 1000, 1100, 1200, 1300, 1400, 1500, and 1600 set forth, described, and/or illustrated herein, or provides functionality set forth, described, and/or illustrated.

As illustrated in FIG. 9, illustrated process block 902 causing, by one or more financial institution servers 200 associated with the financial institution on a user interface 131a, 131b of a client device 100 of a user executing a mobile application or desktop application associated with the financial institution over a communication network, a visual display of a GUI comprising a chat interface to facilitate a virtual chat communication session between the user and a virtual support agent of the financial institution.

The computer-implemented method 900 may then proceed to illustrated process block 904, which includes receiving from the client device 100 by the one or more financial institution servers 200 during the virtual chat communication session, a command to receive a copy of an electronic file of the transcript associated with the virtual chat communication session. It bears noting that the computer-implemented method 900 may commence with the execution of process block 904 instead of the execution of process block 902.

In accordance with process block 904, the command comprises a verbal command or a textual command. Alternatively or additionally, the computer-implemented 900 may include executing, by the one or more financial institution servers, natural language processing (NLP) of the verbal command or the textual command.

The computer-implemented method 900 may then proceed to illustrated process block 906, which includes transmitting, by the one or more financial institution servers 200 in response to the command, a copy of the electronic file of the transcript associated with a previous virtual chat communication session to the client device 100.

The computer-implemented method 900 may terminate or end after execution of process block 906.

Alternatively or additionally, the computer-implemented 900 may proceed to process block 908, which includes transmitting, by the one or more financial institution servers 200 in response to the transmission of the electronic file, a notification of the transmission of the electronic file to the client device 100.

In accordance with process block 908, the notification may comprise an electronic notification that includes a time stamp indicating when the transmission of the electronic file was completed.

In accordance with process block 908, the electronic notification may comprise one or more of a text message, an email, and a chat message associated with the virtual chat communication session.

In accordance with process block 908, the notification may comprise a graphical user interface (GUI) visually displayed on the user interface 131a, 131b of the client device 100.

In accordance with process block 908, the GUI may comprise a pop-up notification of the deletion/erasure of the data and information.

In accordance with process block 908, the pop-up notification may include a time stamp indicating when the transmission of the electronic file was completed.

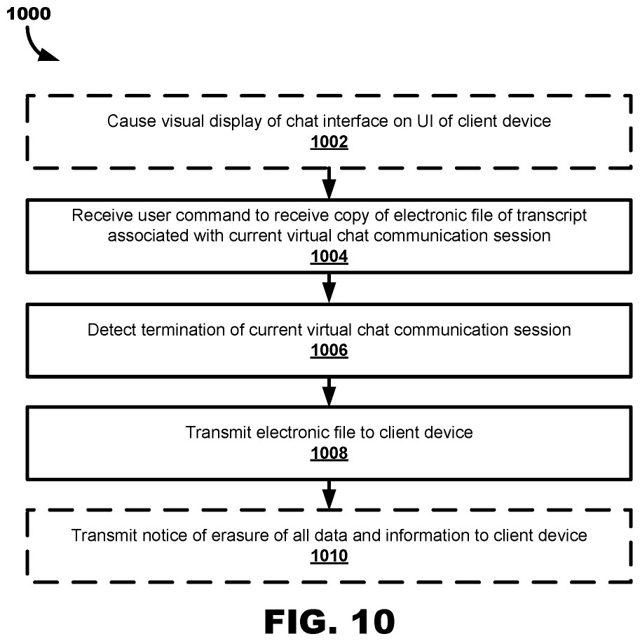

As illustrated in FIG. 10, illustrated process block 1002 includes causing, by one or more financial institution servers 200 associated with the financial institution on a user interface 131a, 131b of a client device 100 of a user executing a mobile application or desktop application associated with the financial institution over a communication network, a visual display of a GUI comprising a chat interface to facilitate a virtual chat communication session between the user and a virtual support agent of the financial institution.

The computer-implemented method 1000 may then proceed to illustrated process block 1004, which includes receiving from the client device 100, by the one or more financial institution servers 200 during the virtual chat communication session, a command to receive a copy of an electronic file of the transcript associated with the virtual chat communication session. It bears noting that the computer-implemented method 1000 may commence with the execution of process block 1004 instead of the execution of process block 1002.

In accordance with process block 1004, the command comprises a verbal command or a textual command. Alternatively or additionally, the computer-implemented 1000 may include executing, by the one or more financial institution servers, natural language processing (NLP) of the verbal command or the textual command.

The computer-implemented method 1000 may then proceed to illustrated process block 1006, which includes detecting termination of the virtual chat communication session.

In accordance with process block 1006, the detection may be based on one or more events that include, but are not limited to, a user textual request or command, a user verbal request or command, and a user engaging a user-engageable icon on the chat interface.

The computer-implemented method 1000 may then proceed to illustrated process block 1008, which includes transmitting, by the one or more financial institution servers 200 in response to the detection, a copy of the electronic file of the transcript associated with the virtual chat communication session to the client device 100.

Alternatively or additionally, the computer-implemented 1000 may proceed to process block 1010, which includes transmitting, by the one or more financial institution servers 200 in response to the transmission of the copy of the electronic file, a notification of the transmission of the copy of the electronic file to the client device 100.

In accordance with process block 1010, the notification may comprise an electronic notification that includes a time stamp indicating when the transmission of the copy of the electronic file was completed.

In accordance with process block 1010, the electronic notification may comprise one or more of a text message, an email, and a chat message associated with the virtual chat communication session.

In accordance with process block 1010, the notification may comprise a graphical user interface (GUI) visually displayed on the user interface 131a, 131b of the client device 100.

In accordance with process block 1010, the GUI may comprise a pop-up notification of the transmission of the copy of the electronic file.

In accordance with process block 1010, the pop-up notification may include a time stamp indicating when the transmission of the copy of the electronic file was completed.

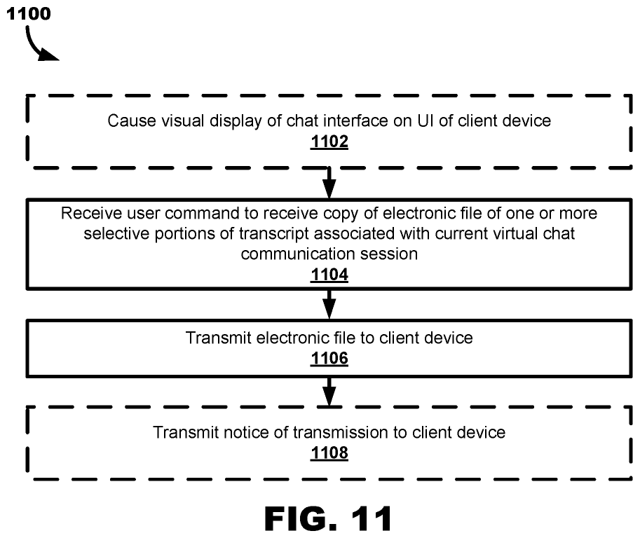

As illustrated in FIG. 11, illustrated process block 1102 causing, by one or more financial institution servers 200 associated with the financial institution on a user interface 131a, 131b of a client device 100 of a user executing a mobile application or desktop application associated with the financial institution over a communication network, a visual display of a GUI comprising a chat interface to facilitate a virtual chat communication session between the user and a virtual support agent of the financial institution.

The computer-implemented method 1100 may then proceed to illustrated process block 1104, which includes receiving from the client device 100, by the one or more financial institution servers 200 during the virtual chat communication session, a command to receive a copy of an electronic file of one or more selective portions of the transcript associated with the current virtual chat communication session. It bears noting that the computer-implemented method 1100 may commence with the execution of process block 1104 instead of the execution of process block 1102.

In accordance with process block 1104, the command comprises a verbal command or a textual command. Alternatively or additionally, the computer-implemented 1100 may include executing, by the one or more financial institution servers, natural language processing (NLP) of the verbal command or the textual command.

The computer-implemented method 1100 may then proceed to illustrated process block 1106, which includes transmitting, by the one or more financial institution servers 200 in response to the command, the copy of the electronic file of the one or more selective portions of the transcript associated with the virtual chat communication session.

Additionally, the computer-implemented method 1100 may include, temporally between the command and the transmission, executing a search of one or more data stores 221 of the one or more financial institution servers 200 for the one or more selective portions of the transcript associated with the current virtual chat communication session. The search may be based on one or more of a time stamp associated with the one or more selective portions of the transcript associated with the current virtual chat communication session, and one or more keywords associated with the one or more selective portions of the transcript associated with the current virtual chat communication session.

Alternatively or additionally, the computer-implemented 1100 may proceed to process block 1108, which includes transmitting, by the one or more financial institution servers 200 in response to the deleting/erasing of the data and information, a notification of the transmission to the client device 100.

In accordance with process block 1108, the notification may comprise an electronic notification that includes a time stamp indicating when the transmission was completed.

In accordance with process block 1108, the electronic notification may comprise one or more of a text message, an email, and a chat message associated with the virtual chat communication session.

In accordance with process block 1108, the notification may comprise a graphical user interface (GUI) visually displayed on the user interface 131a, 131b of the client device 100.

In accordance with process block 1108, the GUI may comprise a pop-up notification of the transmission.

In accordance with process block 1108, the pop-up notification may include a time stamp indicating when the transmission was completed.

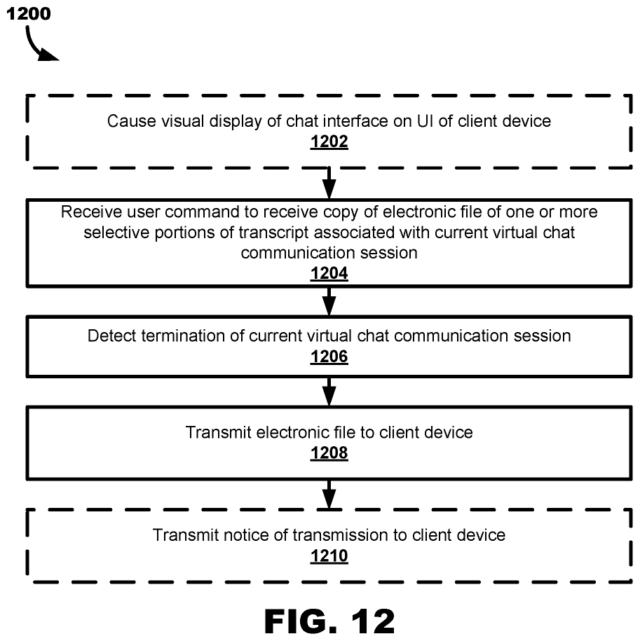

As illustrated in FIG. 12, illustrated process block 1202 causing, by one or more financial institution servers 200 associated with the financial institution on a user interface 131a, 131b of a client device 100 of a user executing a mobile application or desktop application associated with the financial institution over a communication network, a visual display of a GUI comprising a chat interface to facilitate a virtual chat communication session between the user and a virtual support agent of the financial institution.

The computer-implemented method 1200 may then proceed to illustrated process block 1204, which includes receiving from the client device 100, by the one or more financial institution servers 200 during the virtual chat communication session, a command to receive a copy of an electronic file of one or more selective portions of the transcript associated with the current virtual chat communication session. It bears noting that the computer-implemented method 1200 may commence with the execution of process block 1204 instead of the execution of process block 1202.

In accordance with process block 1204, the command comprises a verbal command or a textual command. Alternatively or additionally, the computer-implemented 1100 may include executing, by the one or more financial institution servers, natural language processing (NLP) of the verbal command or the textual command.

In accordance with process block 1204, the data and information comprises personally identifiable information (PII) of the user.

The computer-implemented method 1200 may then proceed to illustrated process block 1206, which includes detecting termination of the virtual chat communication session.

In accordance with process block 1206, the detection may be based on one or more events that include, but are not limited to, a user textual request or command, a user verbal request or command, and a user engaging a user-engageable icon on the chat interface.

The computer-implemented method 1200 may then proceed to illustrated process block 1208, which includes transmitting, by the one or more financial institution servers 200 in response to the command, the copy of the electronic file of the one or more selective portions of the transcript associated with the current virtual chat communication session.

Additionally, the computer-implemented method 1200 may include, temporally between the command and the transmission, executing a search of one or more data stores 221 of the one or more financial institution servers 200 for the one or more selective portions of the transcript associated with the current virtual chat communication session. The search may be based on one or more of a time stamp associated with the one or more selective portions of the transcript associated with the current virtual chat communication session, and one or more keywords associated with the one or more selective portions of the transcript associated with the current virtual chat communication session.

Alternatively or additionally, the computer-implemented 1200 may proceed to process block 1210, which includes transmitting, by the one or more financial institution servers 200 in response to the transmission of the copy of the electronic file, a notification of the transmission of the copy of the electronic file to the client device 100.

In accordance with process block 1210, the notification may comprise an electronic notification that includes a time stamp indicating when the transmission of the copy of the electronic file was completed.

In accordance with process block 1210, the electronic notification may comprise one or more of a text message, an email, and a chat message associated with the virtual chat communication session.

In accordance with process block 1210, the notification may comprise a graphical user interface (GUI) visually displayed on the user interface 131a, 131b of the client device 100.

In accordance with process block 1210, the GUI may comprise a pop-up notification of the transmission of the copy of the electronic file.

In accordance with process block 1210, the pop-up notification may include a time stamp indicating when the transmission of the copy of the electronic file was completed.

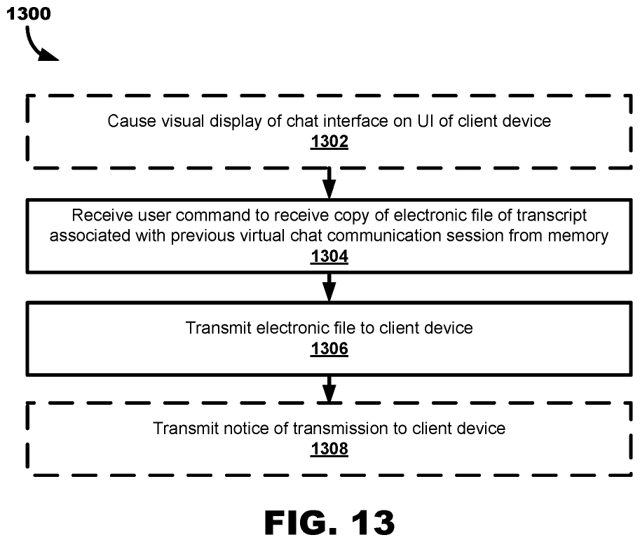

As illustrated in FIG. 13, illustrated process block 1302 causing, by one or more financial institution servers 200 associated with the financial institution on a user interface 131a, 131b of a client device 100 of a user executing a mobile application or desktop application associated with the financial institution over a communication network, a visual display of a GUI comprising a chat interface to facilitate a virtual chat communication session between the user and a virtual support agent of the financial institution.

The computer-implemented method 1300 may then proceed to illustrated process block 1304, which includes receiving from the client device 100, by the one or more financial institution servers 200 during the virtual chat communication session, a command to receive a copy of an electronic file of the transcript associated with a previous virtual chat communication session. It bears noting that the computer-implemented method 1300 may commence with the execution of process block 1304 instead of the execution of process block 1302.

In accordance with process block 1304, the command comprises a verbal command or a textual command. Alternatively or additionally, the computer-implemented method 1300 may include executing, by the one or more financial institution servers, natural language processing (NLP) of the verbal command or the textual command.

The computer-implemented method 1300 may then proceed to illustrated process block 1306, which includes transmitting, by the one or more financial institution servers 200 in response to the command to delete/erase and termination of the virtual chat communication session, the copy of the electronic file of the transcript associated with the previous virtual chat communication session.

Alternatively or additionally, the computer-implemented 1300 may proceed to process block 1308, which includes transmitting, by the one or more financial institution servers 200 in response to the transmission, a notification of the transmission to the client device 100.

In accordance with process block 1308, the notification may comprise an electronic notification that includes a time stamp indicating when the transmission was completed.

In accordance with process block 1308, the electronic notification may comprise one or more of a text message, an email, and a chat message associated with the current virtual chat communication session.

In accordance with process block 1308, the notification may comprise a graphical user interface (GUI) visually displayed on the user interface 131a, 131b of the client device 100.

In accordance with process block 1308, the GUI may comprise a pop-up notification of the transmission.

In accordance with process block 1308, the pop-up notification may include a time stamp indicating when the transmission was completed.

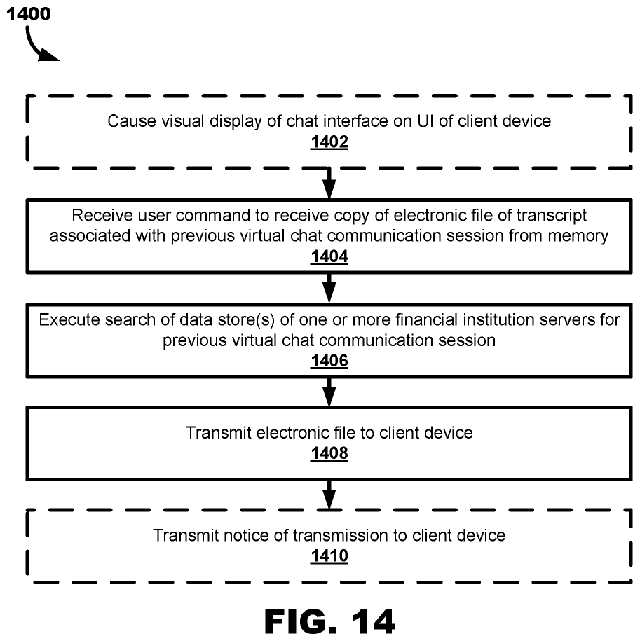

As illustrated in FIG. 14, illustrated process block 1402 includes causing, by one or more financial institution servers 200 associated with the financial institution on a user interface 131a, 131b of a client device 100 of a user executing a mobile application or desktop application associated with the financial institution over a communication network, a visual display of a GUI comprising a chat interface to facilitate a virtual chat communication session between the user and a virtual support agent of the financial institution.

The computer-implemented method 1400 may then proceed to illustrated process block 1404, which includes receiving from the client device 100, by the one or more financial institution servers 200 during the virtual chat communication session, a command to receive a copy of an electronic file of the transcript associated with a previous virtual chat communication session. It bears noting that the computer-implemented method 1400 may commence with the execution of process block 1404 instead of the execution of process block 1402.

In accordance with process block 1404, the command comprises a verbal command or a textual command. Alternatively or additionally, the computer-implemented 1000 may include executing, by the one or more financial institution servers, natural language processing (NLP) of the verbal command or the textual command.

The computer-implemented method 1400 may then proceed to illustrated process block 1406, which includes executing, by the one or more financial institution servers in response to the request or command, a search of one or more data stores 221 of the one or more financial institution servers for the transcript (e.g., digital transcript) of the previous virtual chat communication session.

In accordance with process block 1406, the search may be based on one or more of a time stamp associated with the previous virtual chat communication session, and one or more keywords associated with the previous virtual chat communication session. The time stamp associated with the previous virtual chat communication session may be acquired from the user via the client device 100. The search may be executed concurrently with the current virtual chat communication session (i.e., not after termination of the current virtual chat communication session).

The computer-implemented method 1400 may then proceed to illustrated process block 1408, which includes transmitting, by the one or more financial institution servers 200 in response to the search, the copy of the electronic file of the transcript associated with the previous virtual chat communication session.

Alternatively or additionally, the computer-implemented 1400 may proceed to process block 1410, which includes transmitting, by the one or more financial institution servers 200 in response to the transmission, a notification of the transmission to the client device 100.

In accordance with process block 1410, the notification may comprise an electronic notification that includes a time stamp indicating when the transmission was completed.

In accordance with process block 1410, the electronic notification may comprise one or more of a text message, an email, and a chat message associated with the current virtual chat communication session.

In accordance with process block 1410, the notification may comprise a graphical user interface (GUI) visually displayed on the user interface 131a, 131b of the client device 100.

In accordance with process block 1410, the GUI may comprise a pop-up notification of the transmission.

In accordance with process block 1410, the pop-up notification may include a time stamp indicating when the transmission was completed.

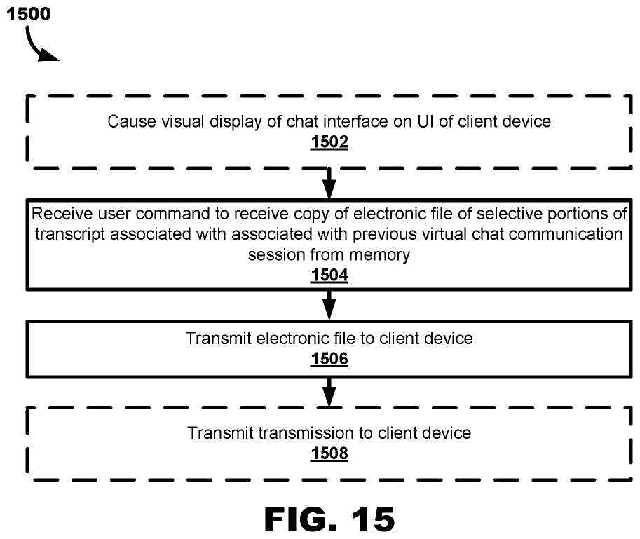

As illustrated in FIG. 15, illustrated process block 1502 causing, by one or more financial institution servers 200 associated with the financial institution on a user interface 131a, 131b of a client device 100 of a user executing a mobile application or desktop application associated with the financial institution over a communication network, a visual display of a GUI comprising a chat interface to facilitate a virtual chat communication session between the user and a virtual support agent of the financial institution.

The computer-implemented method 1500 may then proceed to illustrated process block 1504, which includes receiving from the client device 100 by the one or more financial institution servers 200 during the virtual chat communication session, a command to receive a copy of an electronic file of selective portions of a transcript associated with a previous virtual chat communication session from any memory 220 of the one or more financial institution servers 200. It bears noting that the computer-implemented method 1100 may commence with the execution of process block 1504 instead of the execution of process block 1502.

In accordance with process block 1504, the command comprises a verbal command or a textual command. Alternatively or additionally, the computer-implemented 1500 may include executing, by the one or more financial institution servers, natural language processing (NLP) of the verbal command or the textual command.

The computer-implemented method 1500 may then proceed to illustrated process block 1506, which includes transmitting, by the one or more financial institution servers 200 in response to the command, the copy of the electronic file of the selective portions of the transcript associated with the previous virtual chat communication session.

Alternatively or additionally, the computer-implemented 1500 may proceed to process block 1508, which includes transmitting, by the one or more financial institution servers 200 in response to the transmission, a notification of the transmission to the client device 100.

In accordance with process block 1508, the notification may comprise an electronic notification that includes a time stamp indicating when the transmission was completed.

In accordance with process block 1508, the electronic notification may comprise one or more of a text message, an email, and a chat message associated with the current virtual chat communication session.

In accordance with process block 1508, the notification may comprise a graphical user interface (GUI) visually displayed on the user interface 131a, 131b of the client device 100.

In accordance with process block 1508, the GUI may comprise a pop-up notification of the transmission.

In accordance with process block 1508, the pop-up notification may include a time stamp indicating when the transmission was completed.

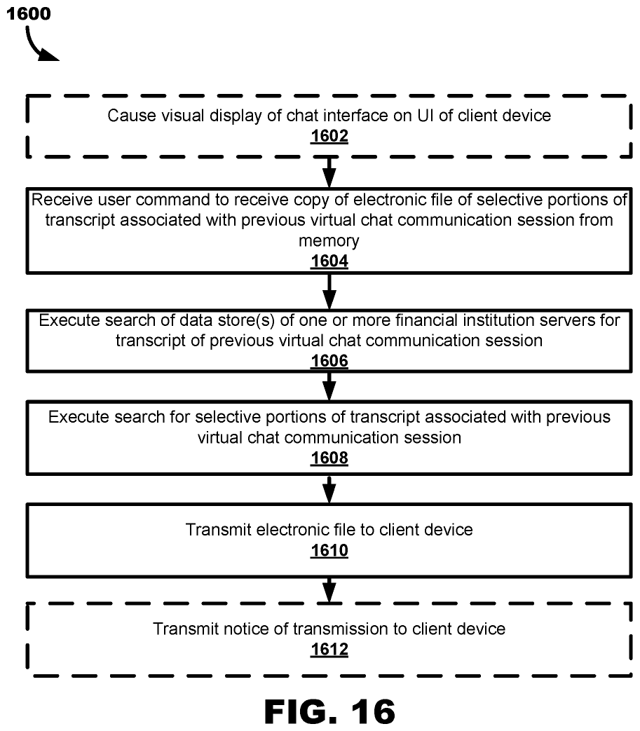

As illustrated in FIG. 16, illustrated process block 1602 causing, by one or more financial institution servers 200 associated with the financial institution on a user interface 131a, 131b of a client device 100 of a user executing a mobile application or desktop application associated with the financial institution over a communication network, a visual display of a GUI comprising a chat interface to facilitate a virtual chat communication session between the user and a virtual support agent of the financial institution.

The computer-implemented method 1600 may then proceed to illustrated process block 1604, which includes receiving from the client device 100, by the one or more financial institution servers 200 during the virtual chat communication session, a command to receive a copy of an electronic file of selective portions of a transcript associated with a previous virtual chat communication session. It bears noting that the computer-implemented method 1100 may commence with the execution of process block 1604 instead of the execution of process block 1602.

In accordance with process block 1604, the command comprises a verbal command or a textual command. Alternatively or additionally, the computer-implemented 1600 may include executing, by the one or more financial institution servers, natural language processing (NLP) of the verbal command or the textual command.

The computer-implemented method 1600 may then proceed to illustrated process block 1606, which includes executing, by the one or more financial institution servers 200 in response to the command, a search of the one or more data stores 221 of the one or more financial institution servers 200 for the transcript of the previous virtual chat communication session. The search may be based on one or more of a time stamp associated with the previous virtual chat communication session, and one or more keywords associated with the previous virtual chat communication session.

The computer-implemented method 1600 may then proceed to illustrated process block 1608, which includes executing, by the one or more financial institution servers 200 in response to locating the transcript of the previous virtual chat communication session, a search of the transcript of the previous virtual chat communication session for the selective portions of the transcript. The search may be based on one or more of a time stamp associated with the selective portions of transcript, and one or more keywords associated with the selective portions of the transcript.

The computer-implemented method 1600 may then proceed to illustrated process block 1610, which includes transmitting, by the one or more financial institution servers 200 in response to the search, the copy of the electronic file of the selective portions of the transcript associated with the previous virtual chat communication session from any memory 220 of the one or more financial institution servers 200.

Alternatively or additionally, the computer-implemented 1600 may proceed to process block 1612, which includes transmitting, by the one or more financial institution servers 200 in response to the transmission, a notification of the transmission of the data and information to the client device 100.

In accordance with process block 1612, the notification may comprise an electronic notification that includes a time stamp indicating when the transmission was completed.

In accordance with process block 1612, the electronic notification may comprise one or more of a text message, an email, and a chat message associated with the current virtual chat communication session.

In accordance with process block 1612, the notification may comprise a graphical user interface (GUI) visually displayed on the user interface 131a, 131b of the client device 100.

In accordance with process block 1612, the GUI may comprise a pop-up notification of the transmission.

In accordance with process block 1612, the pop-up notification may include a time stamp indicating when the transmission was completed.

In accordance with one or more embodiments set forth, described, and/or illustrated herein, the client device 100 and the one or more financial institution servers 200 could function in a fully virtualized environment. A virtual machine is where all hardware is virtual and operation is run over a virtual processor. The benefits of computer virtualization have been recognized as greatly increasing the computational efficiency and flexibility of a computing hardware platform. For example, computer virtualization facilitates multiple virtual computing machines to execute on a common computing hardware platform. Similar to a physical computing hardware platform, virtual computing machines include storage media, such as virtual hard disks, virtual processors, and other system components associated with a computing environment. For example, a virtual hard disk can store the operating system, data, and application files for a virtual machine. Virtualized computer system includes computing device or physical hardware platform, virtualization software running on hardware platform, and one or more virtual machines running on hardware platform by way of virtualization software. Virtualization software is therefore logically interposed between the physical hardware of hardware platform and guest system software running “in” virtual machine.

Memory of the hardware platform may store virtualization software and guest system software running in virtual machine. Virtualization software performs system resource management and virtual machine emulation. Virtual machine emulation may be performed by a virtual machine monitor (VMM) component. In typical implementations, each virtual machine (only one shown) has a corresponding VMM instance. Depending on implementation, virtualization software may be unhosted or hosted. Unhosted virtualization software generally relies on a specialized virtualization kernel for managing system resources, whereas hosted virtualization software relies on a commodity operating system: the “host operating system,” such as Windows or Linux to manage system resources. In a hosted virtualization system, the host operating system may be considered as part of virtualization software.

The system and method described herein may be at least partially processor-implemented, the one or more processors 210 being an example of hardware. For example, at least some of the operations of the computer-implemented methods may be performed by the one or more processors 210 or processor-implemented modules. Moreover, the one or more processors may also operate to support performance of the relevant operations in a “cloud computing” environment or as a “software as a service” (SaaS). For example, at least some of the operations may be performed by a group of computers (as examples of machines including processors), with these operations being accessible via a network (e.g., the Internet) and via one or more appropriate interfaces (e.g., an application program interface (API)).

The performance of certain of the operations may be distributed among the one or more processors 210, not only residing within a single machine, but deployed across a plurality of machines. In some example embodiments, the one or more processors 210 or processor-implemented modules may be located in a single geographic location (e.g., within a home environment, an office environment, or a server farm). In other example embodiments, the one or more processors or processor-implemented modules may be distributed across a plurality of geographic locations.

Devices that are described as in “communication” with each other or “coupled” to each other need not be in continuous communication with each other or in direct physical contact, unless expressly specified otherwise. On the contrary, such devices need only transmit to each other as necessary or desirable, and may actually refrain from exchanging data most of the time. For example, a machine in communication with or coupled with another machine via the Internet may not transmit data to the other machine for long period of time (e.g. weeks at a time). In addition, devices that are in communication with or coupled with each other may communicate directly or indirectly through one or more intermediaries.

The terms “coupled,” “attached,” or “connected” may be used herein to refer to any type of relationship, direct or indirect, between the components in question, and may apply to electrical, mechanical, fluid, optical, electromagnetic, electromechanical, or other connections. Additionally, the terms “first,” “second,” etc. are used herein only to facilitate discussion, and carry no particular temporal or chronological significance unless otherwise indicated. The terms “cause” or “causing” means to make, force, compel, direct, command, instruct, and/or enable an event or action to occur or at least be in a state where such event or action may occur, either in a direct or indirect manner.

Those skilled in the art will appreciate from the foregoing description that the broad techniques of the exemplary embodiments may be implemented in a variety of forms. Therefore, while the embodiments have been described in connection with particular examples thereof, the true scope of the embodiments should not be so limited since other modifications will become apparent to the skilled practitioner upon a study of the drawings, specification, and following claims.

What is claimed is:

1. An apparatus, comprising:
one or more processors; and
a non-transitory memory coupled to the one or more processors, the non-transitory memory including a set of instructions of computer-executable program code, which when executed by the one or more processors, cause the apparatus to:
cause, during execution of a mobile application or desktop application associated with a financial institution by a client device of a user over a communication network, a visual display of a chat interface on the client device to facilitate a virtual chat communication session between the user and a virtual support agent of the financial institution;
receive, from the client device contemporaneously with the virtual chat communication session, a command to receive a copy of an electronic file associated with the virtual chat communication session; and
transmit, in response to the command, the electronic file associated with the virtual chat communication session.

2. The apparatus of claim 1, wherein the set of instructions, which when executed by the one or more processors, cause the apparatus to, temporally before transmitting the electronic file to the client device and in response to the command, execute encryption of the electronic file.

3. The apparatus of claim 1, wherein the command comprises a command to receive a copy of an electronic file containing an entire transcript associated with the virtual chat communication session.

4. The apparatus of claim 1, wherein the command comprises a command to receive a copy of an electronic file containing one or more selective portions of the transcript associated with the virtual chat communication session.

5. The apparatus of claim 1, wherein the set of instructions, which when executed by the one or more processors, cause the apparatus to receive from the client device contemporaneously with the virtual chat communication session, a command to receive a copy of an electronic file associated with a previous virtual chat communication session conducted temporally before the virtual chat communication session.

6. The apparatus of claim 5, wherein the set of instructions, which when executed by the one or more processors, cause the apparatus to execute, in response to the command to receive the copy of the electronic file associated with the previous virtual chat communication session, a search of a storage location for the electronic file.

7. The apparatus of claim 6, wherein the set of instructions, which when executed by the one or more processors, cause the apparatus to transmit, in response to the search and contemporaneously with the virtual chat communication session, the copy of the electronic file associated with the previous virtual chat communication session.

8. A computer program product comprising at least one non-transitory computer readable medium having with a set of instructions of computer-executable program code, which when executed by one or more processors of a computing device, cause the computing device to:
cause, during execution of a mobile application or desktop application associated with a financial institution by a client device of a user over a communication network, a visual display of a chat interface on the client device to facilitate a virtual chat communication session between the user and a virtual support agent of the financial institution;
receive, from the client device contemporaneously with the virtual chat communication session, a command to receive a copy of an electronic file associated with the virtual chat communication session; and
transmit, in response to the command, the electronic file associated with the virtual chat communication session.

9. The computer program product of claim 8, wherein the set of instructions, which when executed by the one or more processors, cause the computing device to execute, temporally before transmitting the electronic file to the client device and in response to the command, encryption of the electronic file.

10. The computer program product of claim 8, wherein the command comprises a command to receive a copy of an electronic file containing an entire transcript associated with the virtual chat communication session.

11. The computer program product of claim 8, wherein the command comprises a command to receive a copy of an electronic file containing one or more selective portions of the transcript associated with the virtual chat communication session.

12. The computer program product of claim 8, wherein the set of instructions, which when executed by the one or more processors, cause the computing device to receive from the client device contemporaneously with the virtual chat communication session, a command to receive a copy of an electronic file associated with a previous virtual chat communication session conducted temporally before the virtual chat communication session.

13. The computer program product of claim 12, wherein the set of instructions, which when executed by the one or more processors, cause the computing device to execute, in response to the command to receive the copy of the electronic file associated with the previous virtual chat communication session, a search of a storage location for the electronic file.

14. The computer program product of claim 13, wherein the set of instructions, which when executed by the one or more processors, cause the computing device to transmit, in response to the search and contemporaneously with the virtual chat communication session, the copy of the electronic file associated with the previous virtual chat communication session to the client device.

15. A computer-implemented method, comprising:
causing, by one or more financial institution servers associated with a financial institution during execution of a mobile application or desktop application associated with the financial institution by a client device of a user over a communication network, a visual display of a chat interface on the client device to facilitate a virtual chat communication session between the user and a virtual support agent of the financial institution;
receiving, by the one or more financial institution servers from the client device contemporaneously with the virtual chat communication session, a command to receive a copy of an electronic file associated with the virtual chat communication session; and
transmitting, by the one or more financial institution servers in response to the command, the electronic file associated with the virtual chat communication session.

16. The computer-implemented method of claim 15, further comprising executing, by the one or more financial institution servers temporally before transmitting the electronic file to the client device and in response to the command, encryption of the electronic file.

17. The computer-implemented method of claim 15, wherein the command comprises a command to receive a copy of an electronic file containing an entire transcript associated with the virtual chat communication session.

18. The computer-implemented method of claim 15, wherein the command comprises a command to receive a copy of an electronic file containing one or more selective portions of the transcript associated with the virtual chat communication session.

19. The computer-implemented method of claim 15, further comprising receiving, by the one or more financial institution servers from the client device contemporaneously with the virtual chat communication session, a command to receive a copy of an electronic file associated with a previous virtual chat communication session conducted temporally before the virtual chat communication session.

20. The computer-implemented method of claim 15, further comprising:
executing, by the one or more financial institution servers in response to the command to receive the copy of the electronic file associated with the previous virtual chat communication session, a search of a storage location for the electronic file, and
transmitting, in response to the search and contemporaneously with the virtual chat communication session, the copy of the electronic file associated with the previous virtual chat communication session.
